(19) United States
(12) Patent Application Publication
(10) Pub. No.: US 2022/0053444 A1
(43) Pub. Date: Feb. 17, 2022

(54) Network Communication Method and Apparatus

(71) Applicant: Alibaba Group Holding Limited, Grand Cayman (KY)

(72) Inventors: Xiaobo Yu, Beijing (CN); Changming Bai, Beijing (CN)

(73) Assignee: Alibaba Group Holding Limited

(21) Appl. No.: 17/481,074

(22) Filed: Sep. 21, 2021

(30) Foreign Application Priority Data
Aug. 13, 2020 (CN) 202010814513.1
Nov. 9, 2020 (CN) 202011242028.8

(51) Int. Cl. H04W 60/00; H04W 48/10; H04W 68/00

(52) U.S. Cl. CPC H04W 60/00; H04W 68/00; H04W 48/10

(57) ABSTRACT

Network communication methods and apparatuses are provided in the embodiments of the present disclosure. The user equipment receives an update message sent by a second network entity through a third network entity. The update message is used to update a terminal route selection policy rule. The terminal route selection policy rule includes a network identification, and the network identification is used to enable the user equipment to select a corresponding network according to an target application. The user equipment sends an update reply message for the update message to the third network entity, to cause the third network entity to send the update reply message to the second network entity. Through the embodiments of the present disclosure, the user equipment can determine a corresponding non-public network and access the network through the application, and obtain a service of a specified application, thus improving the efficiency of network services.

### CROSS REFERENCE TO RELATED PATENT APPLICATIONS

This application claims priority to Chinese Patent Application No. 202010814513.1, filed on 13 Aug. 2020, entitled “Network Communication Method and Apparatus,” and further claims priority to Chinese Patent Application No. 202011242028.8, filed on 9 Nov. 2020, entitled “Network Communication Method and Apparatus,” which are hereby incorporated by reference in their entirety.

### TECHNICAL FIELD

The present disclosure relates to the technical field of networking, and particularly to network communication methods and apparatuses.

### BACKGROUND

A non-public network, which can also be called as a dedicated network or private network, is a deployment method that is different from a public land mobile network (PLMN). A non-public network is mainly used in fields such as industrial Internet of Things, etc. In such field, a vertical industry vendor can provide proprietary services to equipment in a specified industry by building a non-public network. For example, a factory can use a non-public network to serve automated equipment in a plant.

At present, 3GPP proposes that user equipment (UE) can store a list (operator controlled network selector list) or information (Home SP subscription information) locally, which is used in performing a corresponding operation of network selection after receiving a non-public network ID in a broadcast message (paging message) of a non-public network.

However, in some scenarios, a non-public network provides access services for a certain specific application, such as high-definition video (live broadcast), etc. In existing technologies, a problem that a non-public network ID cannot be associated with a specified application exists.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

In view of the above-mentioned problems, network communication method and apparatus are proposed in order to overcome the above-mentioned problems or at least partially solve the above-mentioned problems, and include:

A network communication method, which is applied to user equipment, includes:

the user equipment receiving an update message sent by a second network entity through a third network entity, wherein the update message is used to update a terminal route selection policy rule, the terminal route selection policy rule includes a network identification, and the network identification is used to enable the user equipment to select a corresponding network according to an target application; and

the user equipment sending an update reply message for the update message to the third network entity, to cause the third network entity to send the update reply message to the second network entity.

In implementations, before the user equipment receives the update message sent by the second network entity through the third network entity, the method further includes:

the user equipment predefining the route selection policy rule, wherein the route selection policy rule includes the network identification.

In implementations, the method further includes:

the user equipment updating first network identification list information according to the network identification in the route selection policy rule, wherein the first network identification list information includes network identification(s) that the user equipment is allowed to attempt to access.

In implementations, the network identification includes at least one of the following:

a public land mobile network identification, and a non-public network identification.

In implementations, the update message is sent by the first network entity to the user equipment through the second network entity and the third network entity.

A network communication method, which is applied to user equipment, includes:

the user equipment receiving a broadcast message, wherein the broadcast message includes a target network identification;

determining a network identification from a terminal route selection policy rule corresponding to a target application, and matching the determined network identification with the target network identification when the user equipment triggers to access the target application; and

the user equipment performing network registration according to the target network identification.

In implementations, the network identification includes at least one of the following:

a public land mobile network identification, and a non-public network identification.

A network communication method includes:

a third network entity receiving an update message from a second network entity and sending the update message to user equipment, wherein the update message is used to update a terminal route selection policy rule, the terminal route selection policy rule includes a network identification, and the network identification is used to enable the user equipment to select a corresponding network according to a target application; and

the third network entity receiving an update reply message for the update message from the user equipment, and sending the update reply message to the second network entity.

In implementations, before the third network entity sends the update message to the user equipment, the method further includes:

the third network entity determining whether the user equipment is registered with the network;

the third network entity triggering a network registration process when determining that the user equipment is not registered with the network.

In implementations, the network identification includes at least one of the following:

a public land mobile network identification, and a non-public network identification.

In implementations, the update message is sent by the first network entity to the user equipment through the second network entity and the third network entity.

A network communication method, which is applied to a second network entity, includes:

the second network entity sending an update message to user equipment through a third network entity, wherein the update message is used to update a terminal route selection policy rule, the terminal route selection policy rule includes a network identification, and the network identification is used to enable user equipment to select a corresponding network according to a target application; and

the second network entity receiving an update reply message for the update message from the user equipment through the third network entity.

In implementations, the network identification includes at least one of the following:

a public land mobile network identification, and a non-public network identification.

In implementations, the update message is sent by the first network entity to the user equipment through the second network entity and the third network entity.

A network communication method, which is applied to a first network entity, includes:

the first network entity sending an update message to the user equipment through a second network entity and a third network entity, wherein the update message is used to update a terminal route selection policy rule, the terminal route selection policy rule includes a network identification, and the network identification is used to enable the user equipment to select a corresponding network according to a target application.

In implementations, the network identification includes at least one of the following:

a public land mobile network identification, and a non-public network identification.

A network communication apparatus, which is applied in user equipment, includes:

an update message receiving module configured to receive an update message sent by a second network entity through a third network entity, wherein the update message is used to update a terminal route selection policy rule, the terminal route selection policy rule includes a network identification, and the network identification is used to enable user equipment to select a corresponding network according to a target application; and

an update reply message sending module configured to send an update reply message for the update message to the third network entity, to cause the third network entity to send the update reply message to the second network entity.

In implementations, the apparatus further includes:

a route selection policy rule presetting module configured to preset the route selection policy rule, and the route selection policy rule includes the network identification.

In implementations, the apparatus further includes:

a first network identification list information update module configured to update first network identification list information according to the network identification in the route selection policy rule, wherein the first network identification list information includes network identification(s) that the user equipment is allowed to attempt to access.

In implementations, the network identification includes at least one of the following:

a public land mobile network identification, and a non-public network identification.

In implementations, the update message is sent by the first network entity to the user equipment through the second network entity and the third network entity.

A network communication apparatus, which is applied in user equipment, includes:

a broadcast message receiving module configured to receive a broadcast message, wherein the broadcast message includes a target network identification;

a network identification matching module configured to determine a network identification from the terminal route selection policy rule corresponding to an target application when an access to the target application is triggered, and match the network identification with the target network identification; and

a network registration module configured to perform network registration according to the target network identification.

In implementations, the network identification includes at least one of the following:

a public land mobile network identification, and a non-public network identification.

A network communication apparatus, which is applied to a third network entity, includes:

an update message forwarding module configured to receive an update message from a second network entity and send the update message to user equipment, wherein the update message is used to update a terminal route selection policy rule, the terminal route selection policy rule includes a network identification, and the network identification is used to enable the user equipment to select a corresponding network according to a target application; and

an update reply message forwarding module configured to receive an update reply message for the update message from the user equipment, and send the update reply message to the second network entity.

In implementations, the apparatus further includes:

a registered network determination module configured to determine whether the user equipment is registered with the network, and call a network registration process trigger module when determining that the user equipment is not registered with the network; and

the network registration process trigger module configured to trigger a network registration process.

In implementations, the network identification includes at least one of the following:

a public land mobile network identification, and a non-public network identification.

In implementations, the update message is sent by the first network entity to the user equipment through the second network entity and the third network entity.

A network communication apparatus, which is applied to a second network entity, includes:

a first update message sending module configured to send an update message to user equipment through a third network entity, wherein the update message is used to update a terminal route selection policy rule, the terminal route selection policy rule includes a network identification, and the network identification is used to enable user equipment to select a corresponding network according to a target application; and

an update reply message receiving module configured to receive an update reply message for the update message from the user equipment through the third network entity.

In implementations, the network identification includes at least one of the following:

a public land mobile network identification, and a non-public network identification.

In implementations, the update message is sent by the first network entity to the user equipment through the second network entity and the third network entity.

A network communication apparatus, which is applied to a first network entity, includes:

a second update message sending module configured to send an update message to user equipment through a second network entity and a third network entity, wherein the update message is used to update a terminal route selection policy rule, the terminal route selection policy rule includes a network identification, and the network identification is used to enable the user equipment to select a corresponding network according to a target application.

In implementations, the network identification includes at least one of the following:

a public land mobile network identification, and a non-public network identification.

A network communication method, which is applied to a fifth network entity, includes:

the fifth network entity receiving a second message sent by a fourth network entity, wherein the second message includes a first policy rule, and the first policy rule includes a network identification; and

the fifth network entity sending a third message to a sixth network entity, wherein the third message includes a first policy rule, the first policy rule includes a network identification, the third message is used to cause the sixth network entity to send a fourth message to user equipment through a seventh network entity, the fourth message includes the first policy rule, the first policy rule includes the network identification, and the network identification is used to enable the user equipment to select a corresponding network according to the target application.

In implementations, the network identification includes at least one of the following:

a public land mobile network identification, and a non-public network identification.

In implementations, the second message is a message sent by the fourth network entity to the fifth network entity after receiving the first message sent by the first network entity, and the first message includes the network identification, and includes at least one of the following:

an application identification, a data network name, and network slicing identification information.

In implementations, the second message further includes a first identification, and the first identification is used to cause the fifth network entity to send a third message to the sixth network entity.

In implementations, the third message further includes the first identification, and the first identification is further used to cause the sixth network entity to send the first policy rule to the user equipment in a specified manner.

A network communication method, which is applied to user equipment, includes:

the user equipment receiving a fourth message from a sixth network entity through a seventh network entity, wherein the fourth message includes a first policy rule, the first policy rule includes a network identification, the network identification is used to enable the user equipment to select a corresponding network according to a target application, the fourth message is a message sent by the sixth network entity to the user equipment after receiving a third message sent by a fifth network entity, the third message includes the first policy rule, the first policy rule includes the network identification, the third message is sent by the fifth network entity to the sixth network entity after receiving a second message sent by a fourth network entity, the second message includes the first policy rule, and the first policy rule includes the network identification;

the user equipment returning a reply message for the fourth message to the sixth network entity through the seventh network entity.

A network communication method, which is applied to a sixth network entity, includes:

the sixth network entity receiving a sixth message sent by a fourth network entity, wherein the sixth message includes a second policy rule, and the second policy rule includes a network identification; and

the sixth network entity sending a seventh message to user equipment through a seventh network entity, the seventh message includes the second policy rule, the second policy rule includes the network identification, and the network identification is used to enable the user equipment to select a corresponding network according to a target application.

In implementations, the method further includes:

the sixth network entity receiving a reply message for the seventh message from the user equipment through a seventh network entity.

In implementations, the network identification includes at least one of the following:

a public land mobile network identification, and a non-public network identification.

In implementations, the sixth message is a message sent by the fourth network entity to the sixth network entity after receiving a fifth message sent by a first network entity, and a network identification of the fifth message further includes at least one of the following:

an application identification, a data network name, and network slicing identification information.

In implementations, the sixth message further includes a first identification, and the first identification is used to cause the sixth network entity to send the second policy rule to the user equipment in a specified manner.

A network communication method, which is applied to user equipment, includes:

the user equipment receiving a seventh message from a sixth network entity through a seventh network entity, wherein the seventh message includes a second policy rule, the second policy rule includes a network identification, the network identification is used to enable the user equipment to select a corresponding network according to a target application, the seventh message is a message sent by the sixth network entity to the user equipment through the seventh network entity after receiving a sixth message sent by a fourth network entity, the sixth message includes the second policy rule, and the second policy rule includes the network identification; and

the user equipment returning a reply message to the seventh message to the sixth network entity through the seventh network entity.

A network communication apparatus, which is applied in a fifth network entity, includes:

a second message receiving module configured to receive a second message sent by a fourth network entity, wherein the second message includes a first policy rule, and the first policy rule includes a network identification; and

a third message sending module configured to send a third message to a sixth network entity, wherein the third message includes the first policy rule, the first policy rule includes the network identification, and the third message is used to enable the sixth network entity to send a fourth message to user equipment through a seventh network entity, the fourth message includes the first policy rule, the first policy rule includes the network identification, and the network identification is used to enable the user equipment to select a corresponding network according to a target application.

A network communication apparatus, which is applied in user equipment, includes:

a fourth message receiving module configured to receive a fourth message from the sixth network entity through a seventh network entity, wherein the fourth message includes a first policy rule, the first policy rule includes a network identification, the network identification is used to enable the user equipment to select a corresponding network according to a target application, the fourth message is a message sent by the sixth network entity to the user equipment after receiving a third message sent by a fifth network entity, the third message includes the first policy rule, the first policy rule includes the network identification, the third message is a message sent by the fifth network entity sends to the sixth network entity after receiving a second message sent by a fourth network entity, the second message includes the first policy rule, and the first policy rule includes the network identification; and

a fourth reply message returning module configured to return a reply message for the fourth message to the sixth network entity through the seventh network entity.

A network communication apparatus, which is applied in a sixth network entity, includes:

a sixth message receiving module configured to receive a sixth message sent by a fourth network entity, wherein the sixth message includes a second policy rule, and the second policy rule includes a network identification; and

a seventh message sending module configured to send a seventh message to user equipment through a seventh network entity, wherein the seventh message includes the second policy rule, the second policy rule includes the network identification, and the network identification is used to enable user equipment to select a corresponding network according to a target application.

A network communication apparatus, which is applied in user equipment, includes:

a seventh message receiving module configured to receive a seventh message from a sixth network entity through a seventh network entity, wherein the seventh message includes a second policy rule, the second policy rule includes a network identification, the network identification is used to enable the user equipment to select a corresponding network according to a target application, the seventh message is a message sent by the sixth network entity the user equipment through the seventh network entity after receiving a sixth message sent by a fourth network entity, the sixth message includes the second policy rule, and the second policy rule includes the network identification; and

a seventh reply message returning module configured to return a reply message for the seventh message to the sixth network entity through the seventh network entity.

The embodiments of the present disclosure have the following advantages:

In the embodiments of the present disclosure, an update message sent by a second network entity is received by user equipment through a third network entity. The update message is used to update a terminal route selection policy rule. The terminal route selection policy rule includes a network identification, and the network identification is used to enable the user equipment to select a corresponding network according to a target application. The user equipment sends an update reply message for the update message to the third network entity, so that the third network entity sends the update reply message to the second network entity. As such, the user equipment is enabled to determine a corresponding non-public network and accesses the network through an application, and thereby obtains a service of the specified application, which improves the efficiency of network services.

### BRIEF DESCRIPTION OF THE DRAWINGS

In order to explain the technical solutions of the present disclosure more clearly, accompanying drawings that need to be used in the description of the present disclosure will be briefly introduced hereinafter. Apparently, the accompanying drawings in the following description represent only some embodiments of the present disclosure. One of ordinary skill in the art can also obtain other drawings based on these drawings without making any creative effort.

FIG. 1 is a flowchart of a network communication method according to an embodiment of the present disclosure.

FIG. 2 is a flowchart of another network communication method according to an embodiment of the present disclosure.

FIG. 3 is a flowchart of another network communication method provided by an embodiment of the present disclosure.

FIG. 4 is a flowchart of another network communication method according to an embodiment of the present disclosure.

FIG. 5 is a flowchart of another network communication method according to an embodiment of the present disclosure.

FIG. 6 is a schematic diagram of an example of network communication provided by an embodiment of the present disclosure.

FIG. 7 is a schematic structural diagram of a network communication apparatus provided by an embodiment of the present disclosure.

FIG. 8 is a schematic structural diagram of another network communication apparatus provided by an embodiment of the present disclosure.

FIG. 9 is a schematic structural diagram of another network communication apparatus provided by an embodiment of the present disclosure.

FIG. 10 is a schematic structural diagram of another network communication apparatus provided by an embodiment of the present disclosure.

FIG. 11 is a schematic structural diagram of another network communication apparatus provided by an embodiment of the present disclosure.

FIG. 12 is a flowchart of another network communication method according to an embodiment of the present disclosure.

FIG. 13 is a flowchart of another network communication method according to an embodiment of the present disclosure.

FIG. 14 is a schematic diagram of another example of network communication provided by an embodiment of the present disclosure.

FIG. 15 is a flowchart of another network communication method provided by an embodiment of the present disclosure.

FIG. 16 is a flowchart of another network communication method according to an embodiment of the present disclosure.

FIG. 17 is a schematic diagram of another example of network communication provided by an embodiment of the present disclosure.

FIG. 18 is a schematic structural diagram of another network communication apparatus provided by an embodiment of the present disclosure.

FIG. 19 is a schematic structural diagram of another network communication apparatus provided by an embodiment of the present disclosure.

FIG. 20 is a schematic structural diagram of another network communication apparatus provided by an embodiment of the present disclosure.

FIG. 21 is a schematic structural diagram of another network communication apparatus provided by an embodiment of the present disclosure.

FIG. 22 is a schematic structural diagram of an example device.

### DETAILED DESCRIPTION

In order to make the above objectives, features and advantages of the present disclosure more apparent and understandable, the present disclosure will be further described in detail hereinafter in conjunction with the accompanying drawings and specific embodiments. Apparently, the described embodiments represent a part and not all of the embodiments of the present disclosure. Based on the embodiments of the present disclosure, all other embodiments obtained by one of ordinary skill in the art without making any creative effort shall fall within the scope of protection of the present disclosure.

A non-public network (NPN), which can also be called as a dedicated network or non-public network, is a deployment method that is different from the public land mobile network (PLMN). A non-public network is mainly used in fields such as industrial Internet of Things, etc. In this field, a vertical industry vendor can build a non-public network to provide proprietary services to equipment in a specified industry. For example, a factory can use a non-public network to serve automated equipment in a plant.

Requirements that can be fulfilled by a non-public network are as follows:

1. High quality of service (Quality-of-Service) requirements;

2. High security requirements, in order to meet high security requirements, independent security credentials can be used;

3. Isolation from other networks to prevent public mobile networks from malfunctioning. In addition, for considerations such as performance, security, privacy, etc., network isolation may also be required.

Two main types of non-public networks exist:

Non-public networks of isolated and independent networks (Standalone NPN, SNPN), and non-public networks combined with public mobile networks (Public Network Integrated NPN, PNI-NPN).

SNPN does not rely on PLMN and is independently operated by SNPN operators. Non-independent NPN networks rely on networking with PLMN and are operated by traditional operators.

NPN enhancement is underway in the SA2 version 17 stage of 3GPP, and is mainly aimed at solving how user equipment can securely obtain security credentials corresponding to the non-public network and connect to a NPN network at different NPN networking modes. User equipment uses this strategy to determine how to establish a route for an outgoing data stream. The data stream can be routed to an established PDU session, or can also be offloaded to non-3GPP access outside the PDU session, or can trigger an establishment of a new PDU session.

The embodiments of the present disclosure are described in detail:

A first network entity may be an application function (AF). A second network entity may be a policy control function (PCF). A third network entity may be an access and mobile management function (AMF).

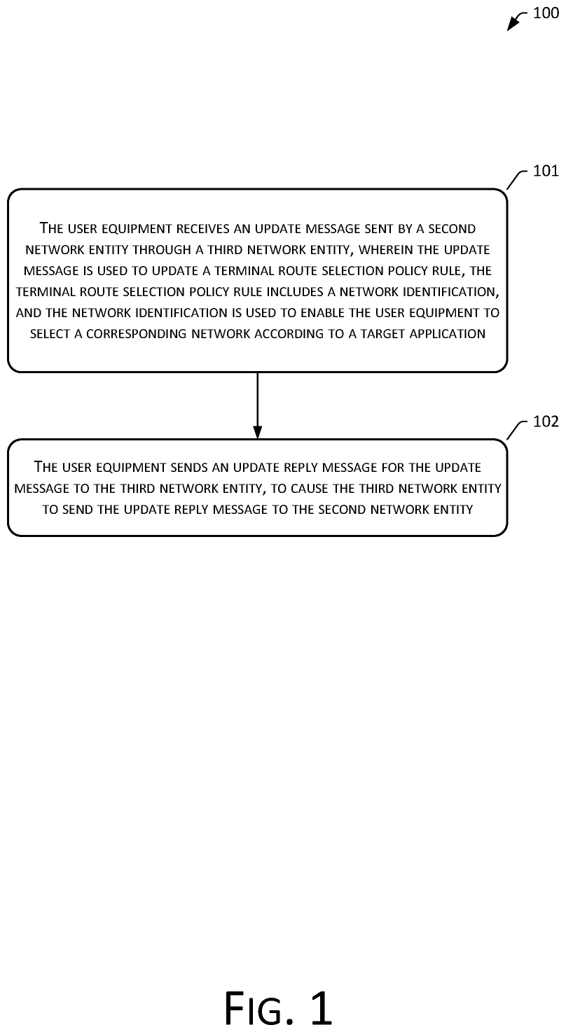

FIG. 1 shows a flowchart of a network communication method 100 provided by an embodiment of the present disclosure. The method 100 can be applied to user equipment, and specifically may include the following steps:

Step 101: The user equipment receives an update message sent by a second network entity through a third network entity, wherein the update message is used to update a terminal route selection policy rule, the terminal route selection policy rule includes a network identification, and the network identification is used to enable the user equipment to select a corresponding network according to a target application.

The terminal route selection policy rule may also be a new terminal policy rule, i.e., the update message is used to create or update a new terminal policy rule. The new terminal policy rule may include a correspondence between the network identification and at least one of an application identification, DNN, and a slice identification.

As an example, the network identification may include at least one of the following:

a public land mobile network identification (PLMN ID), a non-public network identification (PLMN ID+NID).

The public land mobile network identification can be identified by a PLMN ID. A non-public network identification can be identified by a PLMN ID plus a NID.

The update message may be sent by a first network entity to the user equipment through the second network entity and the third network entity.

When an UE Route Selection Policy Rule (URSP) is needed to be updated, or a new terminal policy rule is needed to be created, the first network entity may generate an update message, and send the update message to the second network entity. For example, the update message is an Npcf_UEPolicyControl_Update request message, which can also adopt in other names, but their functions are the same.

The following table 1 shows URSP defined by the 3GPP international standard and non-public network ID of the present solution:

TABLE 1

| Information name | Description |
|---|---|
| Rule priority level | Determines an order in which URSP |
| | rules are enforced in UE |
| Traffic descriptor | This part defines components of |
| | traffic descriptor of URSP rule |
| Application descriptor | It is made of OSId and OSAppld |
| IP descriptor | Target IP triplet (IP address or IPv6 |
| | network prefix, port number, |
| | protocol ID of protocol above IP) |
| Domain Descriptor | FQDN (Fully Qualified Domain |
| | Name) destination |
| Non-IP descriptor | Target information descriptor for |
| | non-IP traffic |
| DNN | Information provided by DNN |
| | matches with this |
| Connectivity | This matches with information |
| | provided by the UE application when |
| | requesting a network connection |
| | with a specific function |
| Route selection | List of route selection descriptors |
| descriptor list | |
| Network identification | Used to enable user equipment |
| | to select a corresponding network |
| | according to a target application |

URSP allows user equipment to determine how to establish a route for an outgoing data stream. The data stream can be routed to an established PDU session, or can be offloaded to non-3GPP access outside the PDU session, or can trigger an establishment of a new PDU session. By adding a non-public network ID (i.e., network identification) field, the user equipment can obtain information of a non-public network through which the application can be accessed from the URSP.

After receiving the update message, the second network entity can send the update message to the third network entity, and the second network entity can also modify the update message and send the modified update message. For example, the modified update message can be a Namf_Communication_N1N2MessageTransfer request message, which can also adopt other names, but their functions are the same.

Specifically, the first network entity may send a non-public network ID and at least one of AppID, DNN, and S-NSSAI to the second network entity. The second network entity may generate a policy rule based on the non-public network ID and at least one of AppID, DNN, and S-NSSAI, and include the policy rule in the update message.

After receiving the update message, the third network entity can determine an identification of the user equipment from the update message, and thereby can determine whether the user equipment has been registered with a network.

If having already registered with a network, the update message is directly sent to the user equipment. If having not registered with a network, a process of network registration is triggered. After the registration is completed, the update message is sent to the user equipment. The third network entity can also modify the update message and the modified update message. For example, the modified update message can be a terminal configuration update command (UE Configuration Update Command), or a DL NAS (Non-Access Stratum) Transport message, or another related NAS message (such as NAS notification), which can also adopt other names, but their function are the same.

Step 102: The user equipment sends an update reply message for the update message to the third network entity, to cause the third network entity to send the update reply message to the second network entity.

After receiving the update message, the user equipment can update a corresponding route selection policy rule according to the update message. The user equipment can also update a locally stored list (such as an operator controlled network selector list) or information (such as home service provider subscription information (Home SP subscription information)) through the network identification in the route selection policy rule. Such list or information can be used for performing a corresponding network selection operation after receiving a non-public network ID in a broadcast message (such as a paging message) of a non-public network. If the user equipment finds that the updated non-public network ID does not have corresponding subscription information or a security credential, the user equipment can download subscription information or a security credential corresponding to the non-public network ID by initiating a connection to a network element that stores subscription information or security credentials (such as UDM, or a server (provisioning server) that provides subscription information or security credentials).

In implementations, the network side may also initiate a configuration update process for the user equipment according to the updated non-public network ID in the URSP for the user equipment, to enable the user equipment to obtain the subscription information or security credential corresponding to the non-public network ID in the URSP. Details of a procedure for user equipment to obtain subscription data or security credential corresponding to a non-public network ID in URSP through a configuration update process include a third network entity obtaining corresponding subscription data or security credential from UDM, and then delivering the subscription data or security credential to the user equipment through a terminal configuration update command for the user equipment (Configuration Update Command) or DL NAS (Non-Access Stratum) Transport message or other related NAS messages (such as NAS notification).

After the route selection policy rule is updated, the user equipment can generate an update reply message for the update message according to an update result, and can send the update reply message to the third network entity.

After receiving the update reply message, the third network entity can send the update reply message to the second network entity, and the second network entity can also modify the update reply message and send the modified update reply message. For example, the modified update reply message can be a Namf_Communication_N1N2MessageNotify message, which can also adopt other names, but their functions are the same.

In an embodiment of the present disclosure, before step 101, the following step may be further included:

the user equipment predefining the route selection policy rule, wherein the route selection policy rule includes the network identification.

In practical applications, a route selection policy rule can be predefined in the user equipment, and the route selection policy rule can include a network identification.

In an embodiment of the present disclosure, the following steps may also be included:

the user equipment updating first network identification list information according to the network identification in the route selection policy rule, wherein the first network identification list information includes network identification(s) that the user equipment is allowed to attempt to access.

In practical applications, the user equipment may update the first network identification list information according to the network identification in the route selection policy rule, and the first network identification list information may include network identification(s) that the user equipment is allowed to attempt to access. For example, the first network identification list information can be a service provider controlled network selection list (Service Provider Controlled Network Selector list) or an equivalent home service provider list.

In the embodiments of the present disclosure, user equipment receives an update message sent by a second network entity through a third network entity. The update message is used to update a terminal route selection policy rule. The terminal route selection policy rule includes a network identification, and the network identification is used to enable the user equipment to select a corresponding network according to a target application. The user equipment sends an update reply message for the update message to the third network entity, so that the third network entity sends the update reply message to the second network entity. As such, the user equipment is enabled to determine a corresponding non-public network and accesses the network through an application, and thereby obtains a service of the specified application, which improves the efficiency of network services.

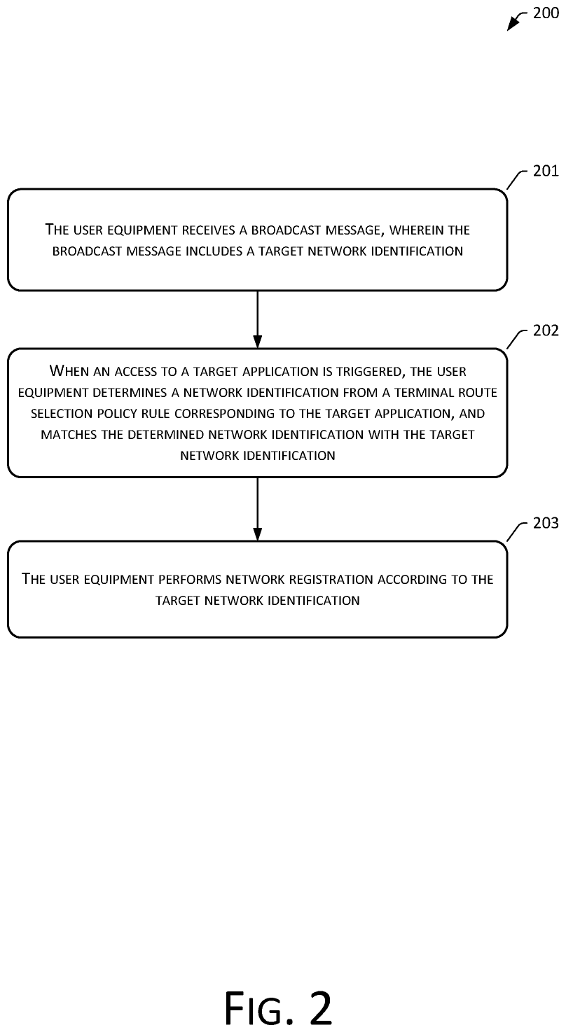

FIG. 2 shows a flowchart of another network communication method 200 according to an embodiment of the present disclosure. The method 200 may be applied to user equipment, and specifically may include the following steps:

Step 201: The user equipment receives a broadcast message, wherein the broadcast message includes a target network identification.

As an example, the network identification may include at least one of the following:

a public land mobile network identification, and a non-public network identification.

The public land mobile network identification can be identified by a PLMN ID. The non-public network identification can be identified by a PLMN ID plus a NID.

In a specific implementation, the user equipment may receive a broadcast message (such as a paging message) of a target non-public network, and the broadcast message may include a target network identification.

Step 202: When an access to a target application is triggered, the user equipment determines a network identification from a terminal route selection policy rule corresponding to the target application, and matches the determined network identification with the target network identification.

When an access to a target application is triggered, the user equipment can determine a network identification from a terminal route selection policy rule corresponding to the target application, and can then match the determined network identification with the target network identification.

Step 203: The user equipment performs network registration according to the target network identification.

After matching with the target network identification, the user equipment can perform network registration according to the target network identification, thereby achieving to find a corresponding non-public network and access the network through the application.

In the embodiments of the present disclosure, user equipment receives a broadcast message. The broadcast message includes a target network identification. When an access to a target application is triggered, the user equipment determines a network identification from a terminal route selection policy rules corresponding to the target application, and matched the determined network identification with the target network identification: The user equipment performs network registration according to the target network identification. This enables the user equipment to determine a corresponding non-public network through the application and access the network, thereby obtaining a service of a specified application and improving the efficiency of network services.

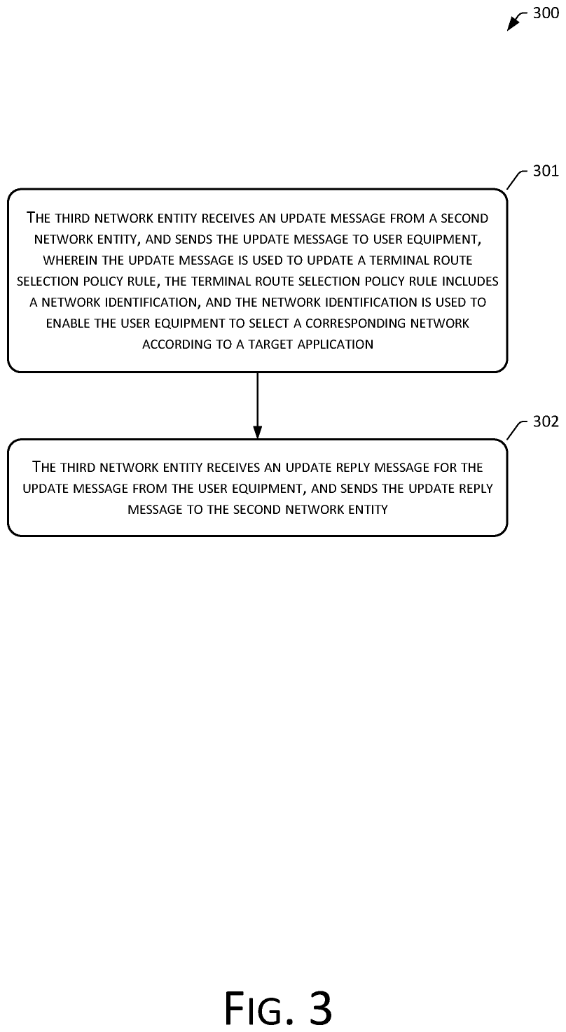

FIG. 3 shows a flowchart of another network communication method 300 according to an embodiment of the present disclosure. The method 300 may be applied to a third network entity, and may specifically include the following steps:

Step 301: The third network entity receives an update message from a second network entity, and sends the update message to user equipment, wherein the update message is used to update a terminal route selection policy rule, the terminal route selection policy rule includes a network identification, and the network identification is used to enable the user equipment to select a corresponding network according to a target application.

The terminal route selection policy rule may also be a new terminal policy rule, i.e., the update message is used to create or update a new terminal policy rule. The new terminal policy rule may include a correspondence between the network identification and at least one of an application identification, a DNN, and a slice identification.

As an example, the network identification may include at least one of the following:

a public land mobile network identification, or a non-public network identification.

The public land mobile network identification can be identified by a PLMN ID. The non-public network identification can be identified by a PLMN ID plus a NID.

The update message may be sent by a first network entity to the user equipment through the second network entity and the third network entity.

When a terminal route selection policy rule is needed to be updated or a new terminal policy rule is needed to be created, the first network entity may generate an update message and send the update message to the second network entity. For example, the update message may be an Npcf_UEPolicyControl_Update request message, which may also adopt other names, but their functions are the same.

After receiving the update message, the second network entity can send the update message to the third network entity, and the second network entity can also modify the update message and send the modified update message. For example, the modified update message can be a Namf_Communication_N1N2MessageTransfer request message, which may also adopt other names, but their functions are the same.

Specifically, the first network entity may send a non-public network ID and at least one of AppID, DNN, and S-NSSAI to the second network entity. The second network entity may generate a policy rule based on the non-public network ID and at least one of AppID, DNN, and S-NSSAI, and include the policy rule in the update message.

After receiving the update message, the third network entity can determine an identification of the user equipment from the update message, and can then determine whether the user equipment has been registered with the network.

If having already registered with the network, the update message is directly sent to the user equipment. If having not registered with the network, a process of network registration is triggered. After the registration is completed, the update message is sent to the user equipment. The third network entity can also modify the update message and send the modified update message. For example, the modified update message can be a terminal configuration update command (UE Configuration Update Command), or a DL NAS Transport message, or other related NAS messages (such as NAS notification), which can also adopt other names, but their functions are the same.

Step 302: The third network entity receives an update reply message for the update message from the user equipment, and sends the update reply message to the second network entity.

After receiving the update message, the user equipment can update a corresponding route selection policy rule according to the update message, and the user equipment can also update a locally stored list through the network identification in the route selection policy rule (such as an operator-controlled network selector list) or information (such as Home SP subscription information). Such list or information can be used for performing a corresponding network selection operation after receiving the non-public network ID in the non-public network broadcast message (such as a paging message) If the user equipment finds that the updated non-public network ID does not have corresponding subscription information or security credential, the user equipment can download the subscription information or security credential corresponding to the non-public network ID by initiating a connection to a network element that stores subscription information or security credentials (such as UDM, or a server (provisioning server) that provides subscription information or security credentials).

In implementations, the network side may also initiate a configuration update process for the user equipment according to the updated non-public network ID in the URSP for the user equipment, to enable the user equipment to obtain the subscription information or security credential corresponding to the non-public network ID in the URSP. Details of a procedure for user equipment to obtain subscription data or security credential corresponding to a non-public network ID in URSP through a configuration update process include a third network entity obtaining corresponding subscription data or security credential from UDM, and then delivering the subscription data or security credential to the user equipment through a terminal configuration update command (UE Configuration Update Command) or DL NAS (Non-Access Stratum) Transport message or other related NAS messages (such as NAS notification).

After the route selection policy rule is updated, the user equipment can generate an update reply message for the update message according to an update result, and can send the update reply message to the third network entity.

After receiving the update reply message, the third network entity can send the update reply message to the second network entity, and the second network entity can also modify the update reply message and send the modified update reply message. For example, the modified update reply message can be a Namf_Communication_N1N2MessageNotify message, which can also adopt other names, but their functions are the same.

In an embodiment of the present disclosure, before step 301, the following steps may be further included:

the third network entity determining whether the user equipment is registered with the network; and the third network entity triggering a network registration process upon determining that the user equipment is not registered with the network.

After receiving the update message, the third network entity can determine an identification of the user equipment from the update message, and can then determine whether the user equipment has been registered with the network.

If having already registered with a network, the update message is directly sent to the user equipment. If having not registered with a network, a process of network registration is triggered. After the registration is completed, the update message is sent to the user equipment. The third network entity can also modify the update message and the modified update message. For example, the modified update message can be a terminal configuration update command (UE Configuration Update Command), or a DL NAS (Non-Access Stratum) Transport message, or another related NAS message (such as NAS notification).

In the embodiments of the present disclosure, an update message is received from a second network entity through a third network entity, and the update message is sent to user equipment. The update message is used to update a terminal route selection policy rule, and the terminal route selection policy rule includes a network identification. The network identification is used to enable the user equipment to select a corresponding network according to a target application. The third network entity receives an update reply message for the update message from the user equipment, and sends the update reply message to the second network entity, thus enabling the user equipment to determine a corresponding non-public network and connect to the network through the application and thereby obtain a service of a specified application, which improves the efficiency of network services.

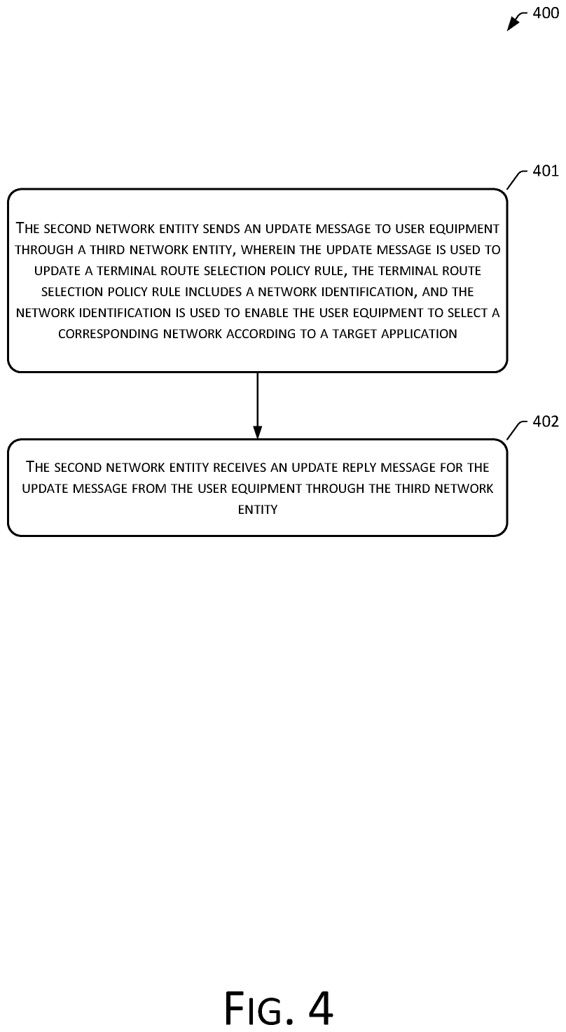

FIG. 4 shows a flowchart of another network communication method 400 according to an embodiment of the present disclosure. The method 400 may be applied to a second network entity, and may specifically include the following steps:

Step 401: The second network entity sends an update message to user equipment through a third network entity, wherein the update message is used to update a terminal route selection policy rule, the terminal route selection policy rule includes a network identification, and the network identification is used to enable the user equipment to select a corresponding network according to a target application.

The terminal route selection policy rule may also be a new terminal policy rule, i.e., the update message is used to create or update a new terminal policy rule. The new terminal policy rule may include a correspondence between the network identification and at least one of an application identification, DNN, and a slice identification.

As an example, the network identification may include at least one of the following:

a public land mobile network identification, or a non-public network identification.

The public land mobile network identification can be identified by a PLMN ID. The non-public network identification can be identified by a PLMN ID plus a NID.

The update message may be sent by a first network entity to the user equipment through the second network entity and the third network entity.

When a terminal route selection policy rule is needed to be updated or a new terminal policy rule is needed to be created, the first network entity may generate an update message and send the update message to the second network entity. For example, the update message may be an Npcf_UEPolicyControl_Update request message, which may also adopt other names, but their functions are the same.

After receiving the update message, the second network entity can send the update message to the third network entity, and the second network entity can also modify the update message and send the modified update message. For example, the modified update message can be a Namf_Communication_N1N2MessageTransfer request message, which may also adopt other names, but their functions are the same.

Specifically, the first network entity may send a non-public network ID and at least one of AppID, DNN, and S-NSSAI to the second network entity. The second network entity may generate a policy rule based on the non-public network ID and at least one of AppID, DNN, and S-NSSAI, and include the policy rule in the update message.

After receiving the update message, the third network entity can determine an identification of the user equipment from the update message, and can then determine whether the user equipment has been registered with the network.

If having already registered with the network, the update message is directly sent to the user equipment. If having not registered with the network, a process of network registration is triggered. After the registration is completed, the update message is sent to the user equipment. The third network entity can also modify the update message and send the modified update message. For example, the modified update message can be a terminal configuration update command (UE Configuration Update Command), or a DL NAS Transport message, or other related NAS messages (such as NAS notification), which can also adopt other names, but their functions are the same.

Step 402: The second network entity receives an update reply message for the update message from the user equipment through the third network entity.

After receiving the update message, the user equipment can update a corresponding route selection policy rule according to the update message, and the user equipment can also update a locally stored list through the network identification in the route selection policy rule (such as an operator-controlled network selector list) or information (such as Home SP subscription information). Such list or information can be used for performing a corresponding network selection operation after receiving the non-public network ID in the non-public network broadcast message (such as a paging message) If the user equipment finds that the updated non-public network ID does not have corresponding subscription information or security credential, the user equipment can download the subscription information or security credential corresponding to the non-public network ID by initiating a connection to a network element that stores subscription information or security credentials (such as UDM, or a server (provisioning server) that provides subscription information or security credentials).

In implementations, the network side may also initiate a configuration update process for the user equipment according to the updated non-public network ID in the URSP for the user equipment, to enable the user equipment to obtain the subscription information or security credential corresponding to the non-public network ID in the URSP. Details of a procedure for user equipment to obtain subscription data or security credential corresponding to a non-public network ID in URSP through a configuration update process include a third network entity obtaining corresponding subscription data or security credential from UDM, and then delivering the subscription data or security credential to the user equipment through a terminal configuration update command (UE Configuration Update Command) or DL NAS (Non-Access Stratum) Transport message or other related NAS messages (such as NAS notification).

After the route selection policy rule is updated, the user equipment can generate an update reply message for the update message according to an update result, and can send the update reply message to the third network entity.

After receiving the update reply message, the third network entity can send the update reply message to the second network entity, and the second network entity can also modify the update reply message and send the modified update reply message. For example, the modified update reply message can be a Namf_Communication_N1N2MessageNotify message, which can also adopt other names, but their functions are the same.

In the embodiments of the present disclosure, a second network entity sends an update message to user equipment through a third network entity. The update message is used to update a terminal route selection policy rule. The terminal route selection policy rule includes a network identification. The network identification is used to make the user equipment to select a corresponding network according to a target application. The second network entity receives an update reply message for the update message from the user equipment through the third network entity. This enables the user equipment to determine a corresponding non-public network and access the network through the application, and then obtains a service of a specified application, thus improving the efficiency of network services.

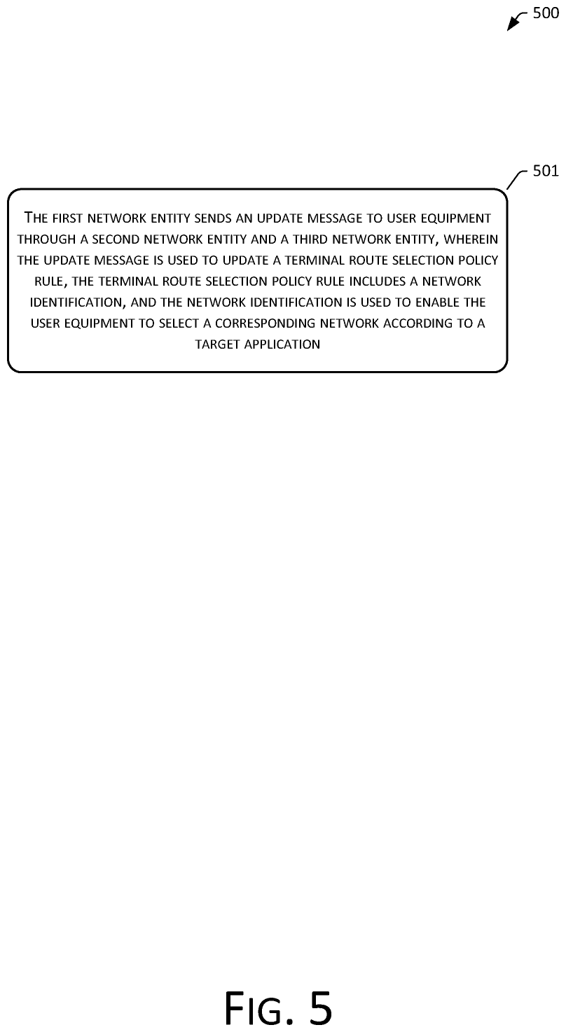

FIG. 5 shows a flowchart of another network communication method 500 according to an embodiment of the present disclosure. The method 500 may be applied to a first network entity, and specifically may include the following steps:

Step 501: The first network entity sends an update message to user equipment through a second network entity and a third network entity, wherein the update message is used to update a terminal route selection policy rule, the terminal route selection policy rule includes a network identification, and the network identification is used to enable the user equipment to select a corresponding network according to a target application.

The terminal route selection policy rule may also be a new terminal policy rule, i.e., the update message is used to create or update a new terminal policy rule. The new terminal policy rule may include a correspondence between the network identification and at least one of an application identification, a DNN, and a slice identification. As an example, the network identification may include at least one of the following:

a public land mobile network identification, or a non-public network identification.

The public land mobile network identification can be identified by a PLMN ID. The non-public network identification can be identified by a PLMN ID plus a NID.

When a terminal route selection policy rule is needed to be updated or a new terminal policy rule is needed to be created, the first network entity may generate an update message and send the update message to the second network entity. For example, the update message may be an Npcf_UEPolicyControl_Update request message, which may also adopt other names, but their functions are the same.

After receiving the update message, the second network entity can send the update message to the third network entity, and the second network entity can also modify the update message and send the modified update message. For example, the modified update message can be a Namf_Communication_N1N2MessageTransfer request message, which may also adopt other names, but their functions are the same.

Specifically, the first network entity may send a non-public network ID and at least one of AppID, DNN, and S-NSSAI to the second network entity. The second network entity may generate a policy rule based on the non-public network ID and at least one of AppID, DNN, and S-NSSAI, and include the policy rule in the update message.

After receiving the update message, the third network entity can determine an identification of the user equipment from the update message, and can then determine whether the user equipment has been registered with the network.

If having already registered with the network, the update message is directly sent to the user equipment. If having not registered with the network, a process of network registration is triggered. After the registration is completed, the update message is sent to the user equipment. The third network entity can also modify the update message and send the modified update message. For example, the modified update message can be a terminal configuration update command (UE Configuration Update Command), or a DL NAS Transport message, or other related NAS messages (such as NAS notification), which can also adopt other names, but their functions are the same.

After receiving the update message, the user equipment can update a corresponding route selection policy rule according to the update message, and the user equipment can also update a locally stored list through the network identification in the route selection policy rule (such as an operator-controlled network selector list) or information (such as Home SP subscription information). Such list or information can be used for performing a corresponding network selection operation after receiving the non-public network ID in the non-public network broadcast message (such as a paging message) If the user equipment finds that the updated non-public network ID does not have corresponding subscription information or security credential, the user equipment can download the subscription information or security credential corresponding to the non-public network ID by initiating a connection to a network element that stores subscription information or security credentials (such as UDM, or a server (provisioning server) that provides subscription information or security credentials).

In implementations, the network side may also initiate a configuration update process for the user equipment according to the updated non-public network ID in the URSP for the user equipment, to enable the user equipment to obtain the subscription information or security credential corresponding to the non-public network ID in the URSP. Details of a procedure for user equipment to obtain subscription data or security credential corresponding to a non-public network ID in URSP through a configuration update process include a third network entity obtaining corresponding subscription data or security credential from UDM, and then delivering the subscription data or security credential to the user equipment through a terminal configuration update command (UE Configuration Update Command) or DL NAS (Non-Access Stratum) Transport message or other related NAS messages (such as NAS notification).

After the route selection policy rule is updated, the user equipment can generate an update reply message for the update message according to an update result, and can send the update reply message to the third network entity.

After receiving the update reply message, the third network entity can send the update reply message to the second network entity, and the second network entity can also modify the update reply message and send the modified update reply message. For example, the modified update reply message can be a Namf_Communication_N1N2MessageNotify message, which can also adopt other names, but their functions are the same.

In the embodiments of the present disclosure, a first network entity sends an update message to user equipment through a second network entity and a third network entity. The update message is used to update a terminal route selection policy rule. The terminal route selection policy rule includes a network identification. The network identification is used to enable the user equipment to select a corresponding network according to a target application, so that the user equipment determines a corresponding non-public network through the application and accesses the network, and then obtains a service of a specified application, thus improves the efficiency of network services.

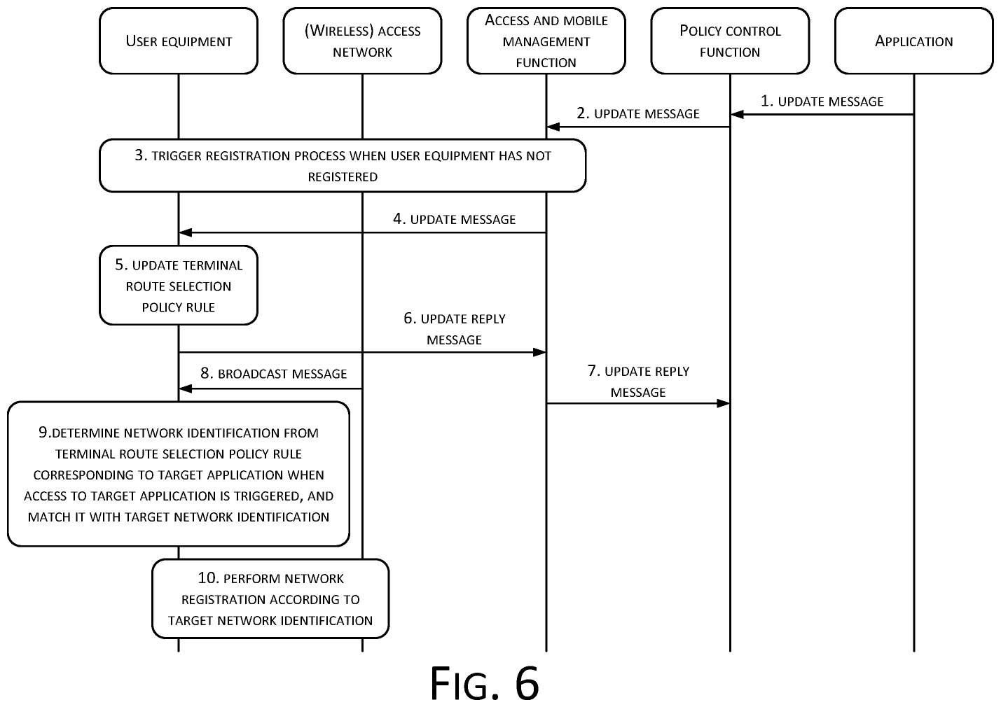

The embodiments of the present disclosure will be exemplarily described below in conjunction with FIG. 6:

1. An application function sends an update message to a policy control function, which may include URSP. URSP includes a non-public network ID, such as PLMN ID+NID. For example, the update message may be an Npcf_UEPolicyControl_Update request message, which can also adopt other names, but their functions are the same.

2. The policy control function sends an update message to an access and mobile management function, which can include URSP. URSP includes a non-public network ID, such as PLMN ID+NID. For example, the update message may be a Namf_Communication_N1N2MessageTransfer request message, which can also adopt other names, but their functions are the same.

3. A registration process is triggered when the user equipment is not registered with the network;

The access and mobile management functions can determine a user equipment ID from the update message, and can then determine whether the user equipment has registered with the network according to the ID. If having not registered with the network, a process of network registration is triggered.

4. The access and mobile management function sends an update message to the user equipment, which may include URSP. URSP includes a non-public network ID, such as PLMN ID+NID. For example, the update message may be a DL NAS Transport message or other related NAS messages (such as NAS notification), which can also adopt other names, but their functions are the same.

5. The user equipment updates a terminal route selection policy rule.

6. The user equipment sends an update reply message for the update message to the access and mobile management functions.

7. The access and mobile management function sends the update reply message to the policy control function, such as Namf_Communication_N1N2MessageNotify message, which can also adopt other names, but their functions are the same.

8. The user equipment receives a broadcast message, which may include a target network identification of a target non-public network, such as PLMN ID+NID.

9. When an access to the target application is triggered, the user equipment determines the network identification from the terminal route selection policy rule corresponding to the target application, and matches the determined network identification with the target network identification.

10. The user equipment performs network registration according to the target network identification.

It should be noted that the method embodiments are all expressed as a series of action combinations for the ease of description. However, one skilled in the art should know that the embodiments of the present disclosure are not limited by the described sequences of actions, because certain steps may be performed in other order or in parallel according to the embodiments of the present disclosure. Moreover, one skilled in the art should also know that the embodiments described in the specification are all exemplary embodiments, and actions involved may not necessarily be required by the embodiments of the present disclosure.

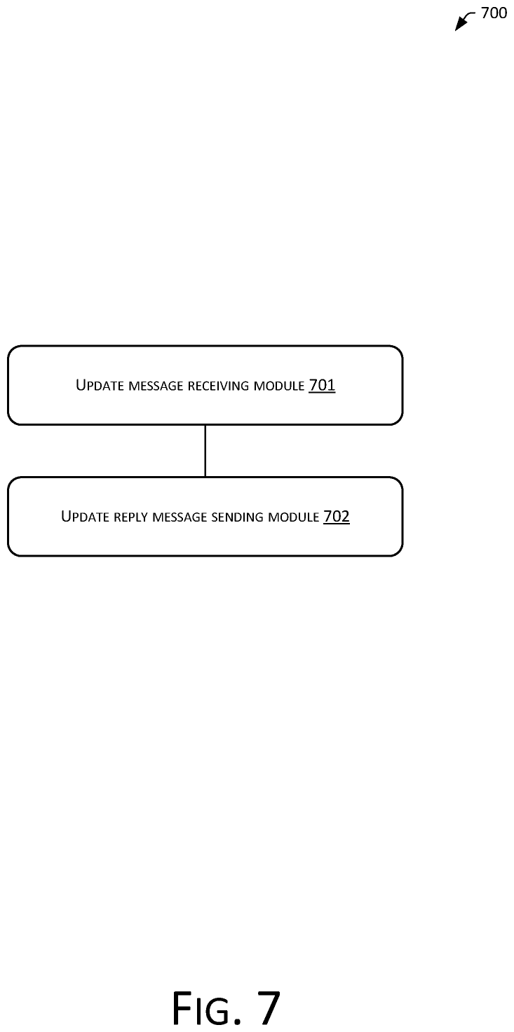

FIG. 7 shows a schematic structural diagram of a network communication apparatus 700 provided by an embodiment of the present disclosure. The apparatus 700 may be applied to user equipment, and specifically may include the following modules:

an update message receiving module 701 configured to receive an update message sent by a second network entity through a third network entity, wherein the update message is used to update a terminal route selection policy rule, the terminal route selection policy rule includes a network identification, and the network identification is used to enable user equipment to select a corresponding network according to a target application; and

an update reply message sending module 702 configured to send an update reply message for the update message to the third network entity, to cause the third network entity to send the update reply message to the second network entity.

In an embodiment of the present disclosure, the apparatus further includes:

a route selection policy rule presetting module configured to preset the route selection policy rule, and the route selection policy rule includes the network identification.

In an embodiment of the present disclosure, the apparatus further includes:

a first network identification list information update module configured to update first network identification list information according to the network identification in the route selection policy rule, wherein the first network identification list information includes network identification(s) that the user equipment is allowed to attempt to access.

In an embodiment of the present disclosure, the network identification includes at least one of the following:

a public land mobile network identification, and a non-public network identification.

In an embodiment of the present disclosure, the update message is sent by the first network entity to the user equipment through the second network entity and the third network entity.

In the embodiments of the present disclosure, user equipment receives an update message sent by a second network entity through a third network entity. The update message is used to update a terminal route selection policy rule. The terminal route selection policy rule includes a network identification, and the network identification is used to enable the user equipment to select a corresponding network according to a target application. The user equipment sends an update reply message for the update message to the third network entity, so that the third network entity sends the update reply message to the second network entity. As such, the user equipment is enabled to determine a corresponding non-public network and accesses the network through an application, and thereby obtains a service of the specified application, which improves the efficiency of network services.

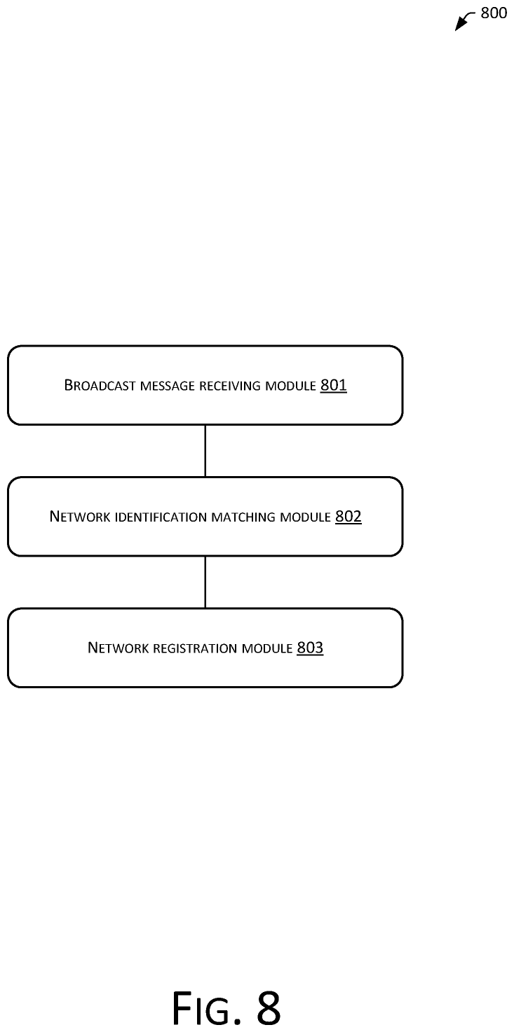

FIG. 8 shows a schematic structural diagram of another network communication apparatus 800 provided by an embodiment of the present disclosure. The apparatus 800 may be applied to user equipment, and specifically may include the following modules:

a broadcast message receiving module 801 configured to receive a broadcast message, wherein the broadcast message includes a target network identification;

a network identification matching module 802 configured to determine a network identification from the terminal route selection policy rule corresponding to an target application when an access to the target application is triggered, and match the network identification with the target network identification; and a network registration module 803 configured to perform network registration according to the target network identification.

In an embodiment of the present disclosure, the network identification includes at least one of the following:

a public land mobile network identification, and a non-public network identification.

In the embodiments of the present disclosure, user equipment receives a broadcast message. The broadcast message includes a target network identification. When an access to a target application is triggered, the user equipment determines a network identification from a terminal route selection policy rules corresponding to the target application, and matched the determined network identification with the target network identification: The user equipment performs network registration according to the target network identification. This enables the user equipment to determine a corresponding non-public network through the application and access the network, thereby obtaining a service of a specified application and improving the efficiency of network services.

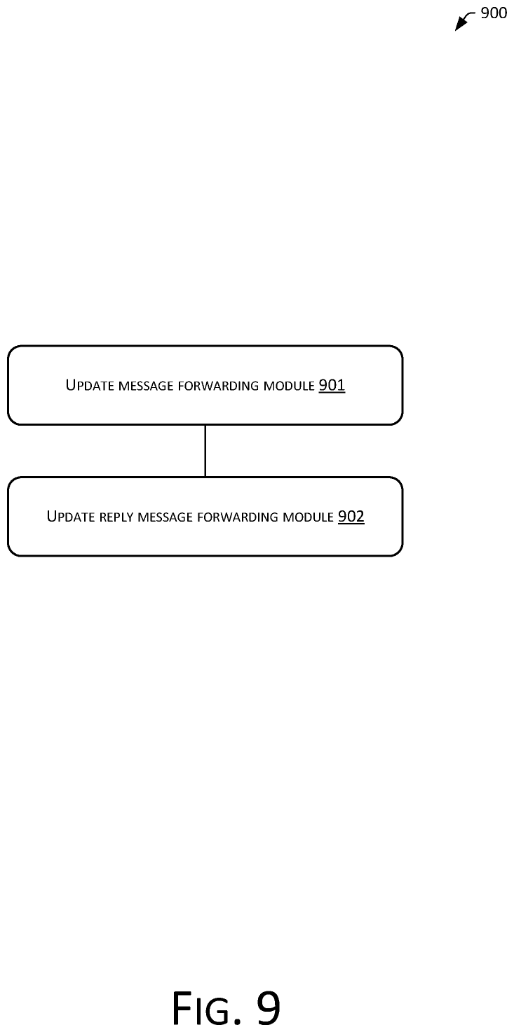

FIG. 9 shows a schematic structural diagram of another network communication apparatus 900 provided by an embodiment of the present disclosure. The apparatus 900 may be applied to a third network entity, and may specifically include the following modules:

an update message forwarding module 901 configured to receive an update message from a second network entity and send the update message to user equipment, wherein the update message is used to update a terminal route selection policy rule, the terminal route selection policy rule includes a network identification, and the network identification is used to enable the user equipment to select a corresponding network according to a target application; and

an update reply message forwarding module 902 configured to receive an update reply message for the update message from the user equipment, and send the update reply message to the second network entity.

In an embodiment of the present disclosure, the apparatus further includes:

a registered network determination module configured to determine whether the user equipment is registered with the network, and call a network registration process trigger module when determining that the user equipment is not registered with the network; and

the network registration process trigger module configured to trigger a network registration process.

In an embodiment of the present disclosure, the network identification includes at least one of the following:

a public land mobile network identification, and a non-public network identification.

In an embodiment of the present disclosure, the update message is sent by the first network entity to the user equipment through the second network entity and the third network entity.

In the embodiments of the present disclosure, an update message is received from a second network entity through a third network entity, and the update message is sent to user equipment. The update message is used to update a terminal route selection policy rule, and the terminal route selection policy rule includes a network identification. The network identification is used to enable the user equipment to select a corresponding network according to a target application. The third network entity receives an update reply message for the update message from the user equipment, and sends the update reply message to the second network entity, thus enabling the user equipment to determine a corresponding non-public network and connect to the network through the application and thereby obtain a service of a specified application, which improves the efficiency of network services.

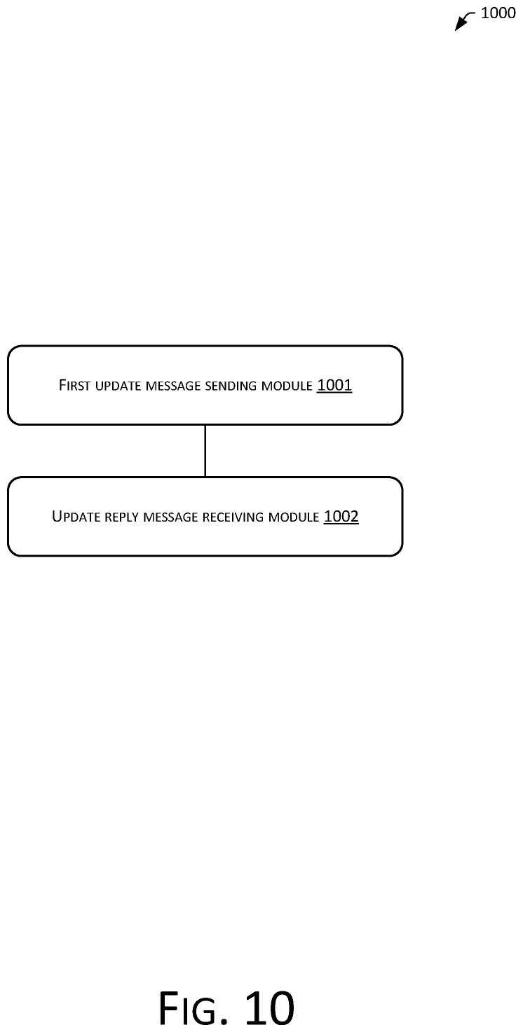

FIG. 10 shows a schematic structural diagram of another network communication apparatus 1000 provided by an embodiment of the present disclosure. The apparatus 1000 may be applied to a second network entity, and may specifically include the following modules:

a first update message sending module 1001 configured to send an update message to user equipment through a third network entity, wherein the update message is used to update a terminal route selection policy rule, the terminal route selection policy rule includes a network identification, and the network identification is used to enable user equipment to select a corresponding network according to a target application; and

an update reply message receiving module 1002 configured to receive an update reply message for the update message from the user equipment through the third network entity.

In an embodiment of the present disclosure, the network identification includes at least one of the following:

a public land mobile network identification, and a non-public network identification.

In an embodiment of the present disclosure, the update message is sent by the first network entity to the user equipment through the second network entity and the third network entity.

In the embodiments of the present disclosure, a second network entity sends an update message to user equipment through a third network entity. The update message is used to update a terminal route selection policy rule. The terminal route selection policy rule includes a network identification. The network identification is used to make the user equipment to select a corresponding network according to a target application. The second network entity receives an update reply message for the update message from the user equipment through the third network entity. This enables the user equipment to determine a corresponding non-public network and access the network through the application, and then obtains a service of a specified application, thus improving the efficiency of network services.

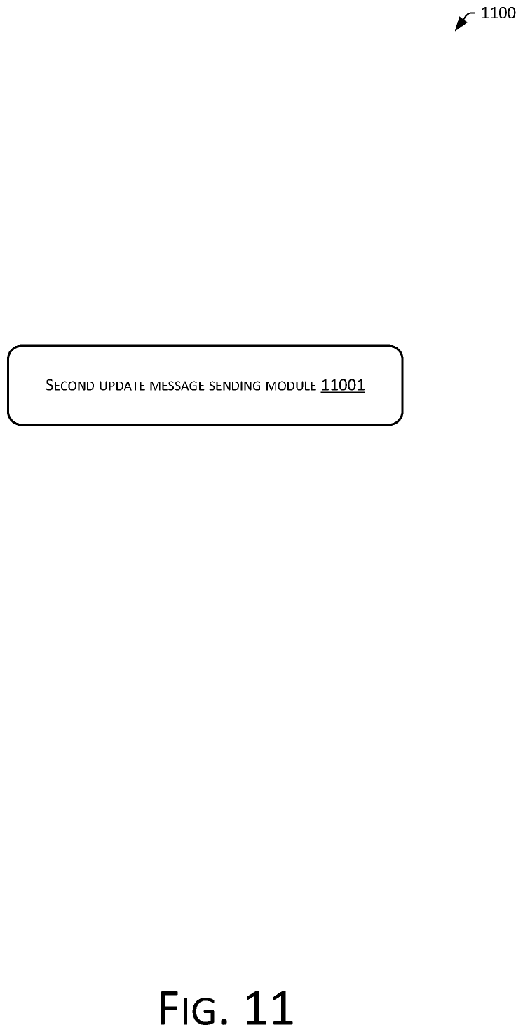

FIG. 11 shows a schematic structural diagram of another network communication apparatus 1100 provided by an embodiment of the present disclosure. The apparatus 1100 may be applied to a first network entity, and may specifically include the following modules:

a second update message sending module 11001 configured to send an update message to user equipment through a second network entity and a third network entity, wherein the update message is used to update a terminal route selection policy rule, the terminal route selection policy rule includes a network identification, and the network identification is used to enable the user equipment to select a corresponding network according to a target application.

In an embodiment of the present disclosure, the network identification includes at least one of the following:

a public land mobile network identification, and a non-public network identification.

In the embodiments of the present disclosure, a first network entity sends an update message to user equipment through a second network entity and a third network entity. The update message is used to update a terminal route selection policy rule. The terminal route selection policy rule includes a network identification. The network identification is used to enable the user equipment to select a corresponding network according to a target application, so that the user equipment determines a corresponding non-public network through the application and accesses the network, and then obtains a service of a specified application, thus improves the efficiency of network services.

An embodiment of the present disclosure also provides a network entity, which may include a processor, a memory, and a computer program stored on the memory and capable of running on the processor. When executed by the processor, the computer program implements the above network communication method.

An embodiment of the present disclosure also provides a computer-readable storage medium, the computer-readable storage medium storing a computer program. When executed by the processor, the computer program implements the above network communication method.

Due to their basic similarities to the method embodiments, descriptions of the apparatus embodiments are relatively simple, and related portions can be referenced to the portions of the descriptions of the method embodiments.

It should be noted that a first network entity may be an application function entity (AF, Application Function). A second network entity may be a policy control function entity (PCF, Policy Control Function). A third network entity may be an access and mobile management Function (AMF, Access and Mobile Management Function). A fourth network entity is a home network policy control function entity (H-PCF, Home Network-Policy Control Function). A fifth network entity is a home network access and mobile management function entity (H-AMF, Home Network-Access and Mobile Management Function), or a home network session management function entity (H-SMF, Home Network-Session Management Function). A sixth network entity is a home network unified data management function entity (H-UDM, Home Network-Unified Data Management). A seventh network entity is a visited network access and mobile management function entity (V-AMF, Visited Network-Access and Mobile Management Function). An eighth network entity is a network exposure function entity (NEF, Network Exposure Function). In implementations, in a non-roaming scenario, the seventh network entity may also be a home network access and mobile management function entity (H-AMF, Home Network-Access and Mobile Management Function).

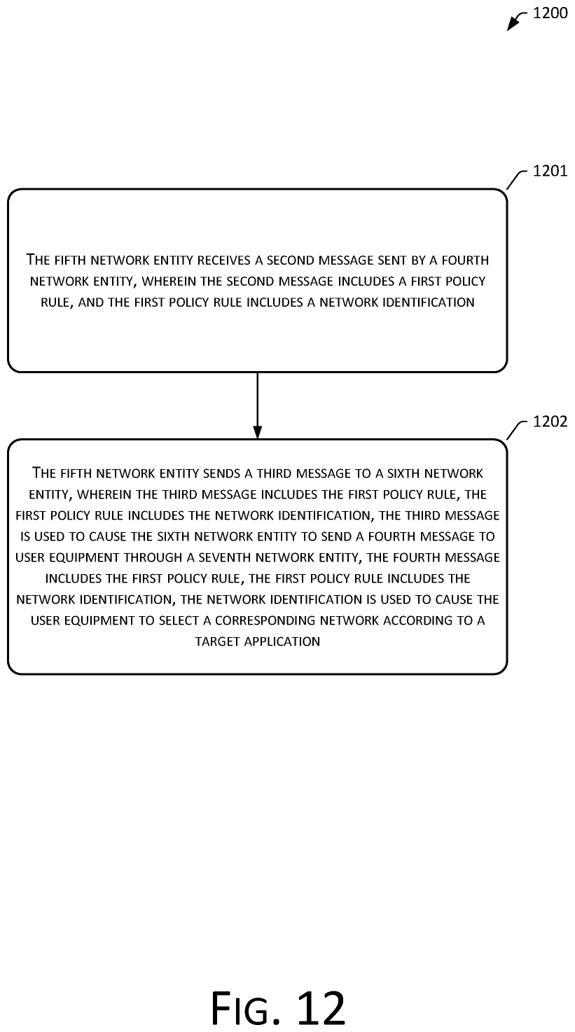

FIG. 12 shows a flowchart of another network communication method 1200 provided by an embodiment of the present disclosure. The method 1200 may be applied to a fifth network entity, and may specifically include the following steps:

Step 1201: The fifth network entity receives a second message sent by a fourth network entity, wherein the second message includes a first policy rule, and the first policy rule includes a network identification.

The second message may be a message sent by the fourth network entity to the fifth network entity after receiving a first message sent by a first network entity, and the first message includes a network identification, and may further include at least one of the following:

an application identification (App ID), a data network name (DNN), network slice identification information (S-NSSAI, Single Network Slice Selection Assistance Information).

As an example, the network identification includes at least one of the following:

a public land mobile network identification, or a non-public network identification.

In a specific implementation, the first network entity may send the first message to the fourth network entity through an eighth network entity, where the first message includes the network identification, and may further include at least one of the following:

an application identification, a data network name, and network slice identification information.

After receiving the first message, the fourth network entity can generate a first policy rule based on the network identification in the first message, and the application identification or data network name or network slice identification information. The first policy rule includes the network identification. A policy rule can be a terminal route selection policy rule (URSP) or a new terminal policy rule. The fourth network entity can then generate a second message according to the first policy rule, and send the first message to the fifth network entity.

The second message may include the first policy rule including the network identification, and may include a first identification. The first identification may be a terminal parameter update indication (UPU indication, UE parameter update indication). The first identification may be used to cause the fifth network entity to send the third message to the sixth network entity. If there is no terminal parameter update instruction, the fifth network entity sends the first policy rule to a terminal according to a terminal configuration update (UE configuration update) procedure. In other words, the first identification can enable the fifth network entity to forward the first policy rule to the sixth network entity, so that the sixth network entity can send the first policy rule to the terminal through the UE parameter update procedure.

Step 1202: The fifth network entity sends a third message to a sixth network entity, wherein the third message includes the first policy rule, the first policy rule includes the network identification, the third message is used to cause the sixth network entity to send a fourth message to user equipment through a seventh network entity, the fourth message includes the first policy rule, the first policy rule includes the network identification, the network identification is used to cause the user equipment to select a corresponding network according to a target application.

The third message may further include the first identification, and the first identification may be used to enable the sixth network entity to send the first policy rule to the user equipment in a designated manner, that is, according to the terminal configuration update procedure.

After receiving the second message, the fifth network entity may send a third message to a sixth network entity according to the first identification. The third message may include the first policy rule that includes the network identification, and may include the first identification. The first identification may be a terminal parameter update indication (UPU indication, UE parameter update indication). The first identification may be used to enable the sixth network entity to send the first policy rule to the user equipment in a designated manner, i.e., to send the first policy rule to the user equipment in a UPU manner If there is no terminal parameter update instruction, the fifth network entity sends the first policy rule to the terminal according to a terminal configuration update (UE configuration update) procedure. In other words, the first identification can enable the fifth network entity to forward the first policy rule to the sixth network entity, so that the sixth network entity can send the first policy rule to the terminal through the UE parameter update procedure.

After receiving the third message, the sixth network entity may trigger a terminal parameter update (UPU, UE parameter update) procedure, and then may send a fourth message to the user equipment through a seventh network entity. The fourth message may include the first policy rule that includes the network identification.

After receiving the fourth message, the user equipment may return a reply message for the fourth message to the sixth network entity through the seventh network entity, determine a network identification from a first policy rule corresponding to a target application when an access to the target application is triggered, and thereby match the determined network identification with a target network identification.

After matching with the target network identification, the user equipment can perform network registration according to the target network identification, thus achieving to find a corresponding non-public network and access the network through the application.

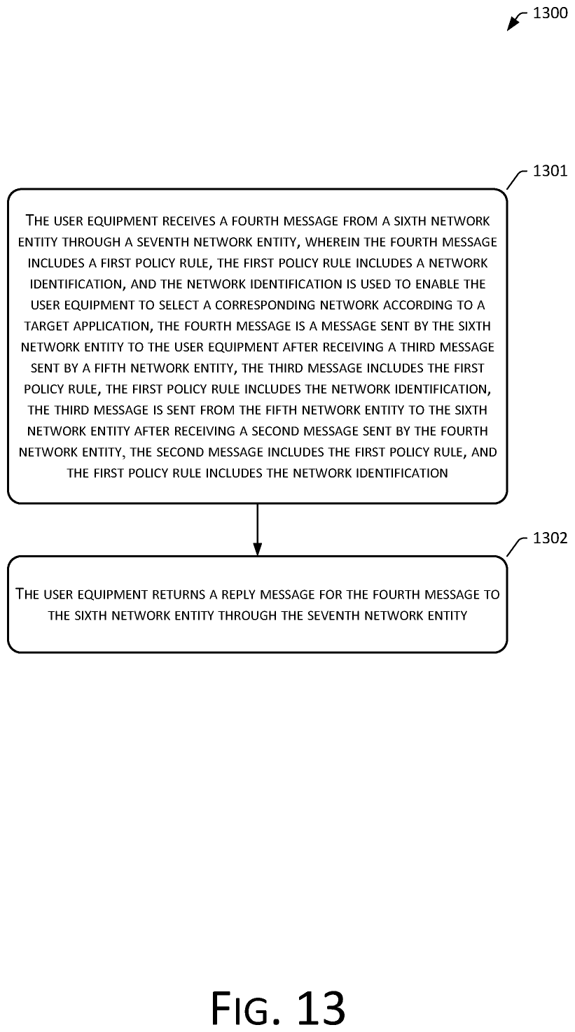

FIG. 13 shows a flowchart of another network communication method 1300 according to an embodiment of the present disclosure. The method 1300 may be applied to user equipment, and specifically may include the following steps:

Step 1301: The user equipment receives a fourth message from a sixth network entity through a seventh network entity, wherein the fourth message includes a first policy rule, the first policy rule includes a network identification, and the network identification is used to enable the user equipment to select a corresponding network according to a target application, the fourth message is a message sent by the sixth network entity to the user equipment after receiving a third message sent by a fifth network entity, the third message includes the first policy rule, the first policy rule includes the network identification, the third message is sent from the fifth network entity to the sixth network entity after receiving a second message sent by the fourth network entity, the second message includes the first policy rule, and the first policy rule includes the network identification.

Step 1302: The user equipment returns a reply message for the fourth message to the sixth network entity through the seventh network entity.

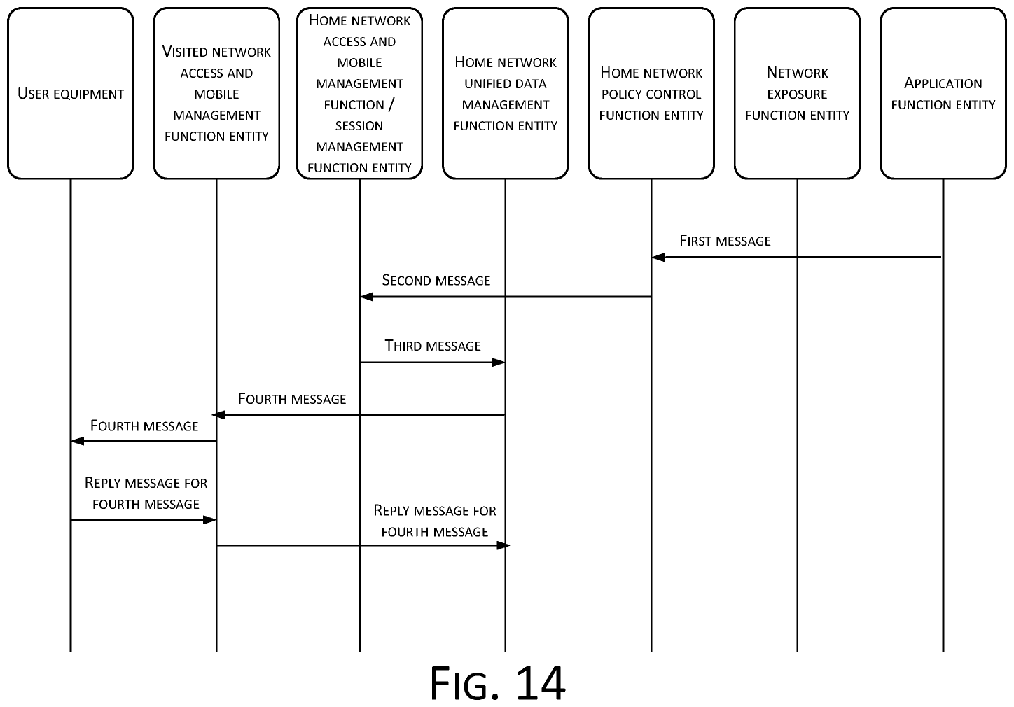

The embodiments of the present disclosure will be exemplarily described below in conjunction with FIG. 14:

1. An application function entity sends a first message to a home network policy control function entity through a network exposure function entity. For example, the first message may be the Npcf_PolicyAuthorization_update message, which may also be named in other ways, but their functions are the same. The message includes a non-public network ID, such as PLMN ID+NID, and may further include at least one of three parameters: App ID, DNN, and S-NSSAI.

2. The home network policy control function entity generates a corresponding URSP or a new terminal policy rule through the non-public network ID and AppID or DNN or S-NSSAI, and then sends a second message to a home network access and mobile management function entity or a home network session management function entity. For example, when a receiving end is the home network access and mobile management function entity, the second message may be a Namf_Communication_N1N2MessageTransfer message. When the receiving end is the home network session management function entity, the second message may be a Npcf_SMPolicyControl_UPdateNotify message. Other names may also be adopted, but their functions are the same. The message includes a URSP that carries the non-public network ID or the new terminal policy rule, and in implementations, a UPU indication.

3. The home network access and mobile management function entity or the home network session management function entity sends a third message to a home network unified data management function entity according to the UPU indication. The third message may be a Nudm_SDM_info message, which may adopt other names, but their functions are the same. The message includes URSP carrying the non-public network ID or the new terminal policy rule and, in implementations, the UPU indication.

4. The home network unified data management function entity triggers a process of UE parameter update, and may send a fourth message to user equipment through a visited network access and mobile management function entity. Specifically, the home network unified data management function entity may send a Nudm_SDM_Notification message to the visited network access and mobile management function entity. The message includes URSP that includes the non-public network ID or the new terminal policy rule. The visited network access and mobile management function entity sends a DL NAS TRANSPORT message to the user equipment. Such message includes URSP that includes the non-public network ID or the new terminal policy rule. Other names may also be adopted, but their functions are the same.

5. The user equipment returns a reply message for the fourth message to the home network unified data management function entity through the visited network access and mobile management function entity. Specifically, the user equipment returns a UL NAS TRANSPORT message to the visited network access and mobile management function entity, and the visited network access and the mobile management function entity returns a Nudm_SDM_info message to the home network unified data management function entity. Other names can also be adopted, but their functions are the same.

6. The user equipment triggers a handover to the non-public network, and finds a corresponding non-public network ID (PLMN ID+NID) from URSP corresponding to a specified application or the new terminal policy rule, and matches the found non-public network ID with a non-public network ID in a paging message (PLMN ID+NID), or update a SNPN list through the URSP or the new terminal policy rule.

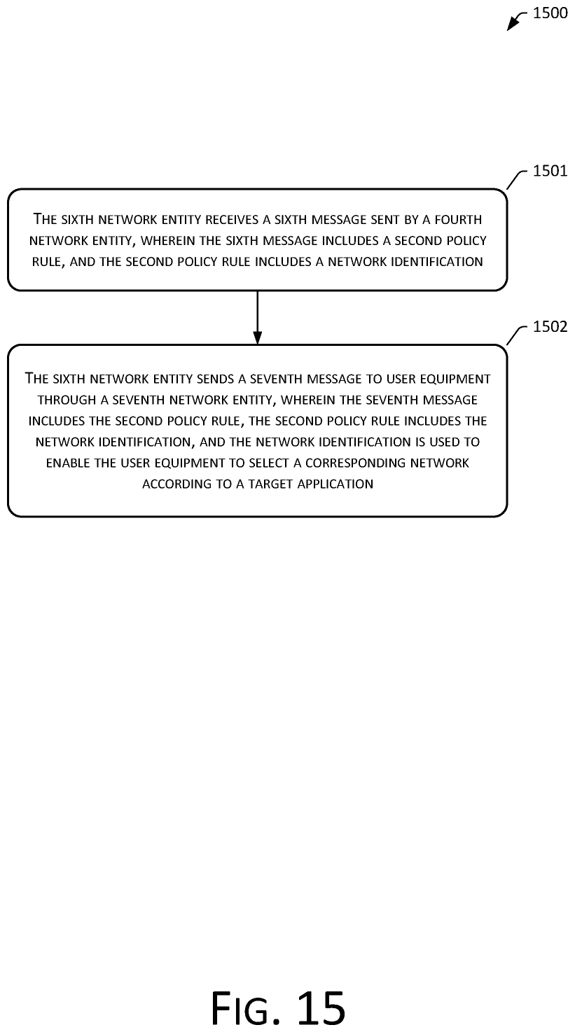

FIG. 15 shows a flowchart of another network communication method 1500 according to an embodiment of the present disclosure. The method 1500 may be applied to a sixth network entity, and may specifically include the following steps:

Step 1501: The sixth network entity receives a sixth message sent by a fourth network entity, wherein the sixth message includes a second policy rule, and the second policy rule includes a network identification.

The sixth message may be a message sent by the fourth network entity to the sixth network entity after receiving a fifth message sent by a first network entity, and the fifth message includes a network identification, and may further include at least one of the following:

an application identification, a data network name, and network slice identification information.

In an embodiment of the present disclosure, the sixth message may further include a first identification, and the first identification may be used to enable the sixth network entity to send the second policy rule to user equipment in a specified manner.

As an example, the network identification may include at least one of the following:

a public land mobile network identification, and a non-public network identification.

In a specific implementation, the first network entity may send the fifth message to the fourth network entity through an eighth network entity, where the fifth message includes a network identification, and may further include at least one of the following:

an application identification, a data network name, and network slice identification information.

After receiving the fifth message, the fourth network entity can generate a second policy rule based on the network identification in the fifth message, and the application identification or data network name or network slice identification information. The second policy rule includes the network identification. The second policy rule can be a terminal route selection policy rule (URSP) or a new terminal policy rule. The fourth network entity can then generate a sixth message according to the second policy rule, and then send the sixth message to the sixth network entity.

The sixth message may include a second policy rule carrying a network identification, and may include a first identification. The first identification may be a terminal parameter update indication (UPU indication, UE parameter update indication), and the first identification may be used to cause the sixth network entity to send the second policy rule to the user equipment in a specified manner, i.e., to send the second policy rule to the user equipment in a UPU manner. If there is no terminal parameter update instruction, the sixth network entity sensed the second policy rule to the terminal according to a terminal configuration update (UE configuration update) procedure. In other words, the first identification may enable the sixth network entity to send the second policy rule to the terminal through a terminal parameter update (UE parameter update) procedure.

Step 1502: The sixth network entity sends a seventh message to user equipment through a seventh network entity, wherein the seventh message includes the second policy rule, the second policy rule includes the network identification, and the network identification is used to enable the user equipment to select a corresponding network according to a target application.

In an embodiment of the present disclosure, the following sub-steps may also be included:

the sixth network entity receiving a reply message for the seventh message from the user equipment through the seventh network entity.

After receiving the sixth message, the sixth network entity triggers a terminal parameter update procedure, and may then send the seventh message to the user equipment through the seventh network entity. The seventh message may include the second policy rule carrying the network identification.

After receiving the seventh message, the user equipment may return a reply message for the seventh message to the sixth network entity through the seventh network entity, determine from the second policy rule corresponding to a target application when an access to the target application is triggered, and match the determined network identification with a target network identification.

After matching with the target network identification, the user equipment can perform network registration according to the target network identification, thereby achieving to find a corresponding non-public network and access the network through the application.

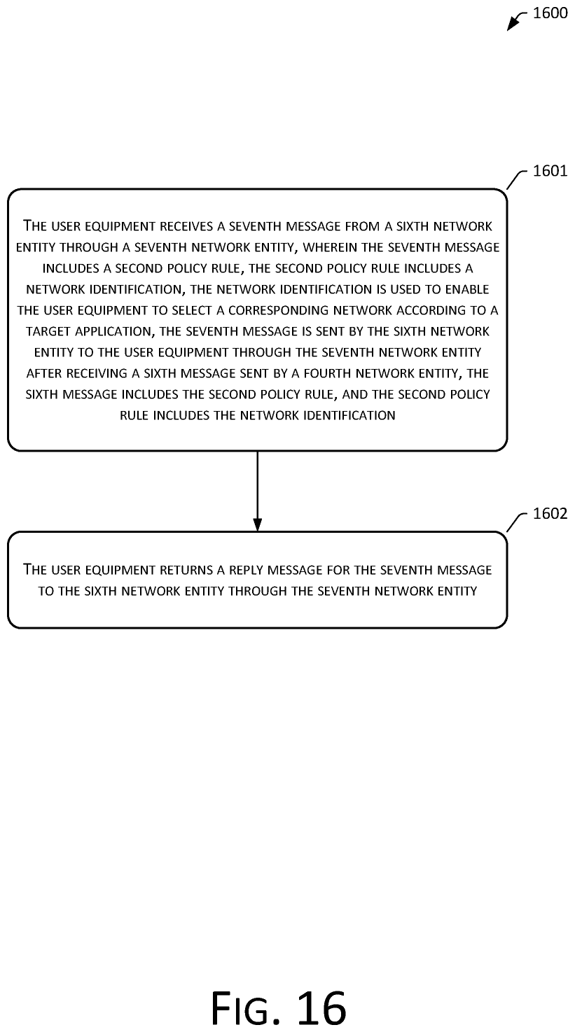

FIG. 16 shows a flowchart of another network communication method 1600 according to an embodiment of the present disclosure. The method 1600 may be applied to user equipment, and specifically may include the following steps:

Step 1601: The user equipment receives a seventh message from a sixth network entity through a seventh network entity, wherein the seventh message includes a second policy rule, the second policy rule includes a network identification, the network identification is used to enable the user equipment to select a corresponding network according to a target application, the seventh message is sent by the sixth network entity to the user equipment through the seventh network entity after receiving a sixth message sent by a fourth network entity, the sixth message includes the second policy rule, and the second policy rule includes the network identification.

Step 1602: The user equipment returns a reply message for the seventh message to the sixth network entity through the seventh network entity.

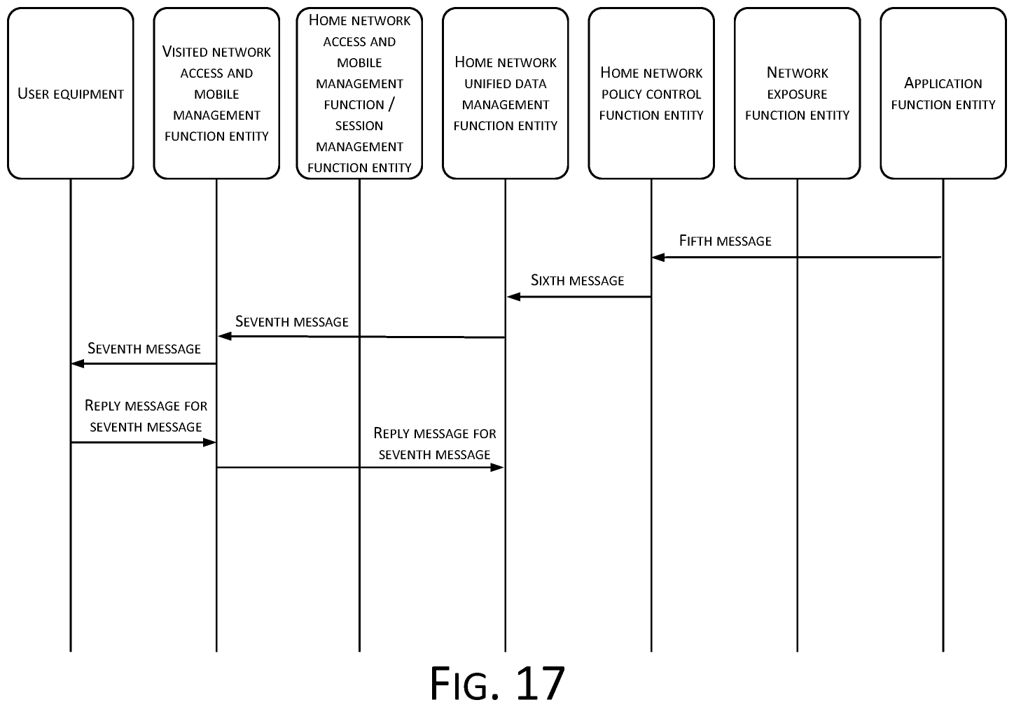

The embodiments of the present disclosure will be exemplarily described below in conjunction with FIG. 17:

1. An application function entity sends a fifth message to a home network policy control function entity through a network exposure function entity. The fifth message may be a Npcf_PolicyAuthorization_update message, which can also be named in other ways, but their functions are the same. The message includes a non-public network ID. for example, PLMN ID+NID, and may further include at least one of three parameters: App ID, DNN, and S-NSSAI.

2. The home network policy control function entity generates a corresponding URSP or a new terminal policy rules using the non-public network ID and AppID or DNN or S-NSSAI, and sends a sixth message to the home network unified data management function entity. For example, the sixth message may be a Nudm_SDM_info message or a new interface message, which may adopt other names, but the functions are the same. The message includes a URSP containing a non-public network ID or a new terminal policy rule and, in implementations, a UPU indication.

3. The home network unified data management function entity triggers a process of UE parameter update, and may send a seventh message to user equipment through a visited network access and mobile management function entity. Specifically, the home network unified data management function entity may send a Nudm_SDM_Notification message to the visited network access and mobile management function entity. The message includes the URSP containing the non-public network ID or the new terminal policy rule. The visited network access and mobile management function entity sends a DL NAS TRANSPORT message to the user equipment. The message includes the URSP containing the non-public network ID or the new terminal policy rule, which can also be named in other ways, but their functions are the same.

4. The user equipment returns a reply message for the seventh message to the home network unified data management function entity through the visited network access and mobile management function entity. Specifically, the user equipment returns a UL NAS TRANSPORT message to the visited network access and mobile management function entity. The visited network access and mobile management function entity returns a Nudm_SDM_info message to the home network unified data management function entity, which can also adopt other names, but their functions are the same.

5. The user equipment triggers the handover to the non-public network, and finds a corresponding non-public network ID (PLMN ID+NID) from URSP corresponding to a specified application or the new terminal policy rule, and matches the found non-public network ID with a non-public network ID in a paging message (PLMN ID+NID), or update a SNPN list through the URSP or the new terminal policy rule.

It should be noted that the method embodiments are all expressed as a series of action combinations for the ease of description. However, one skilled in the art should know that the embodiments of the present disclosure are not limited by the described orders of actions, because certain steps may be performed in other orders or in parallel according to the embodiments of the present disclosure. Moreover, one skilled in the art should also know that the embodiments described in the specification are all exemplary embodiments, and actions involved may not necessarily be required by the embodiments of the present disclosure.

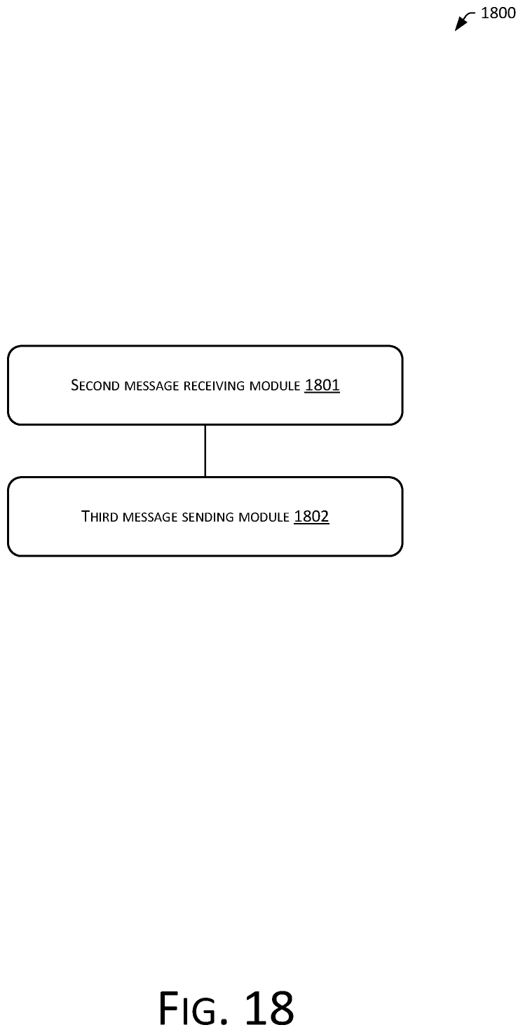

FIG. 18 shows a schematic structural diagram of another network communication apparatus 1800 provided by an embodiment of the present disclosure. The apparatus 1800 may be applied to a fifth network entity, and may specifically include the following modules:

a second message receiving module 1801 configured to receive a second message sent by a fourth network entity, wherein the second message includes a first policy rule, and the first policy rule includes a network identification; and

a third message sending module 1802 configured to send a third message to a sixth network entity, wherein the third message includes the first policy rule, the first policy rule includes the network identification, and the third message is used to enable the sixth network entity to send a fourth message to user equipment through a seventh network entity, the fourth message includes the first policy rule, the first policy rule includes the network identification, and the network identification is used to enable the user equipment to select a corresponding network according to a target application.

In an embodiment of the present disclosure, the network identification includes at least one of the following:

a public land mobile network identification, and a non-public network identification.

In an embodiment of the present disclosure, the second message is a message sent by the fourth network entity to the fifth network entity after receiving a first message sent by a first network entity, and the first message includes the network identification and further includes at least one of the following:

an application identification, a data network name, and network slice identification information.

In an embodiment of the present disclosure, the second message further includes a first identification, and the first identification is used to enable the fifth network entity to send a third message to the sixth network entity.

In an embodiment of the present disclosure, the third message further includes the first identification, and the first identification is also used to enable the sixth network entity to send the first policy to the user equipment in a specified manner.

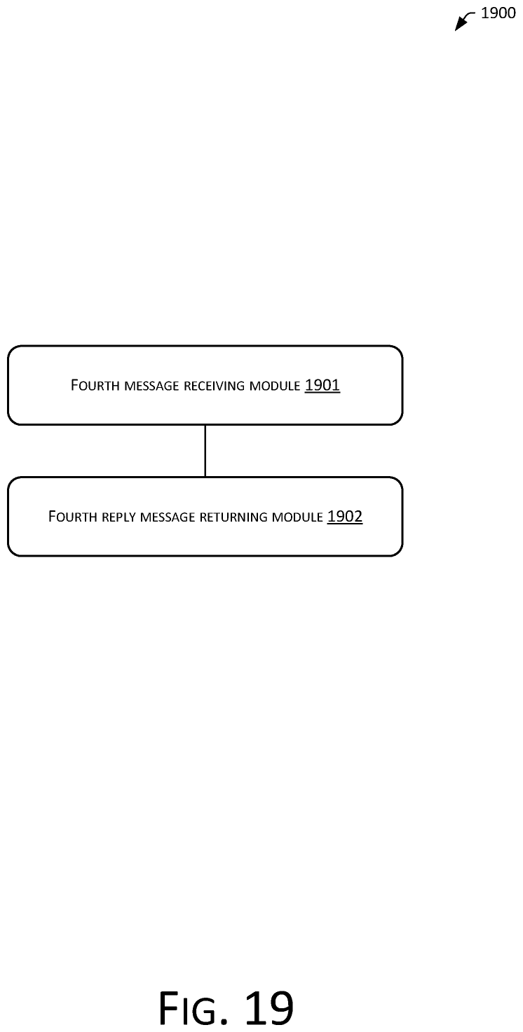

FIG. 19 shows a schematic structural diagram of another network communication apparatus 1900 provided by an embodiment of the present disclosure. The apparatus 1900 may be applied to user equipment, and specifically may include the following modules:

a fourth message receiving module 1901 configured to receive a fourth message from the sixth network entity through a seventh network entity, wherein the fourth message includes a first policy rule, the first policy rule includes a network identification, the network identification is used to enable the user equipment to select a corresponding network according to a target application, the fourth message is a message sent by the sixth network entity to the user equipment after receiving a third message sent by a fifth network entity, the third message includes the first policy rule, the first policy rule includes the network identification, the third message is a message sent by the fifth network entity sends to the sixth network entity after receiving a second message sent by a fourth network entity, the second message includes the first policy rule, and the first policy rule includes the network identification; and

The fourth reply message returning module 1902 configured to return a reply message for the fourth message to the sixth network entity through the seventh network entity.

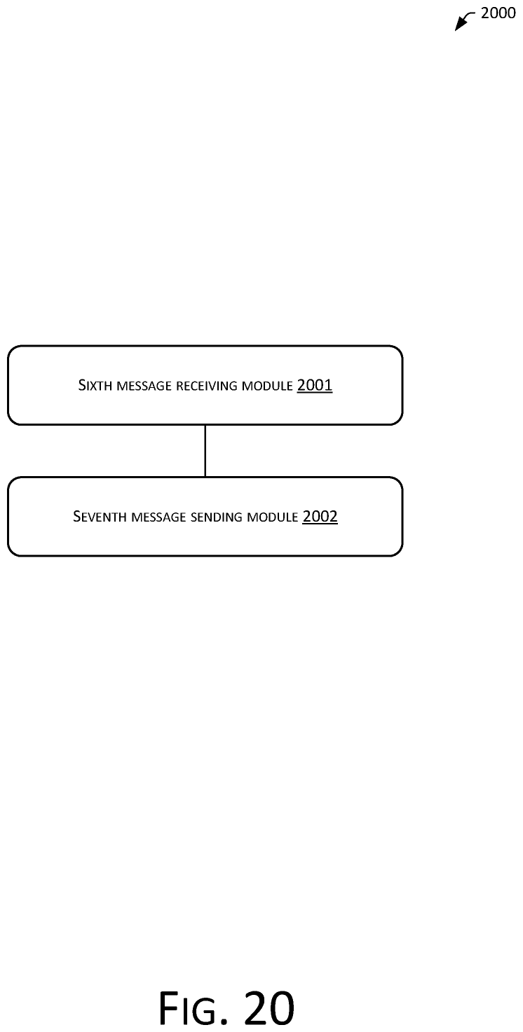

FIG. 20 shows a schematic structural diagram of another network communication apparatus 2000 provided by an embodiment of the present disclosure. The apparatus 2000 may be applied to a sixth network entity, and may specifically include the following modules:

a sixth message receiving module 2001 configured to receive a sixth message sent by a fourth network entity, wherein the sixth message includes a second policy rule, and the second policy rule includes a network identification; and

The seventh message sending module 2002 configured to send a seventh message to user equipment through a seventh network entity, wherein the seventh message includes the second policy rule, the second policy rule includes the network identification, and the network identification is used to enable user equipment to select a corresponding network according to a target application.

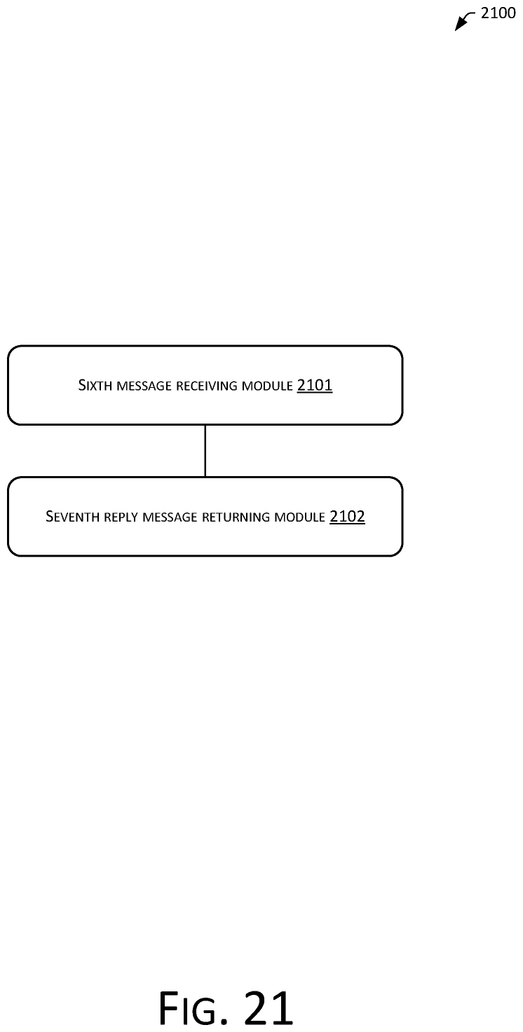

FIG. 21 shows a schematic structural diagram of another network communication apparatus 2100 according to an embodiment of the present disclosure. The apparatus 2100 may be applied to user equipment, and specifically may include the following modules:

a seventh message receiving module 2101 configured to receive a seventh message from a sixth network entity through a seventh network entity, wherein the seventh message includes a second policy rule, the second policy rule includes a network identification, the network identification is used to enable the user equipment to select a corresponding network according to a target application, the seventh message is a message sent by the sixth network entity the user equipment through the seventh network entity after receiving a sixth message sent by a fourth network entity, the sixth message includes the second policy rule, and the second policy rule includes the network identification; and

a seventh reply message returning module 2102 configured to return a reply message for the seventh message to the sixth network entity through the seventh network entity.

In an embodiment of the present disclosure, the apparatus further includes:

the sixth network entity receiving a reply message for the seventh message from the user equipment through the seventh network entity.

In an embodiment of the present disclosure, the network identification includes at least one of the following:

a public land mobile network identification, and a non-public network identification.

In an embodiment of the present disclosure, the sixth message is a message sent by the fourth network entity to the sixth network entity after receiving a fifth message sent by a first network entity, and the fifth message includes network Identification, and further includes at least one of the following:

an application identification, a data network name, and network slice identification information.

In an embodiment of the present disclosure, the sixth message further includes a first identification, and the first identification is used to enable the sixth network entity to send the second policy rule to the user equipment in a specified manner.

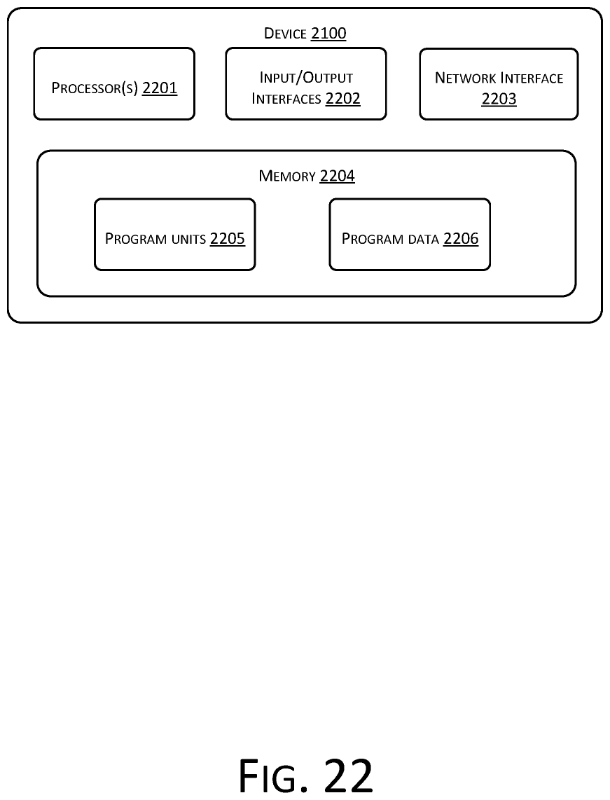

FIG. 22 shows an example device 2200. In implementations, the example device 2200 may represent any one of the foregoing network communication apparatuses and network entities (such as the first network entity, the second network entity, etc.). By way of example and not limitation, the device 2200 may include one or more processors 2201, an input/output (I/O) interface 2202, a network interface 2203, and memory 2204.

The memory 2204 may include a form of computer readable media such as a volatile memory, a random access memory (RAM) and/or a non-volatile memory, for example, a read-only memory (ROM) or a flash RAM. The memory 2204 is an example of a computer readable media. In implementations, the memory 2204 may include program units 2205 and program data 2206.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

Due to their basic similarities to the method embodiments, descriptions of the apparatus embodiments are relatively simple, and related portions can be referenced to the portions of the descriptions of the method embodiments.

Various embodiments in the present specification are described in a progressive manner. Each embodiment focuses on aspects that are different from other embodiments, and same or similar parts between the various embodiments can be referenced to each other.

One skilled in the art should understand that the embodiments of the present disclosure may be provided as a method, an apparatus, or a computer program product. Therefore, the embodiments of the present disclosure may adopt a form of a complete hardware embodiment, a complete software embodiment, or an embodiment that is a combination of software and hardware. Moreover, the embodiments of the present disclosure may adopt a form of a computer program product implemented on one or more computer-usable storage media (which include, but are not limited to, a magnetic disk storage device, CD-ROM, an optical storage device, etc.) that include computer-usable program codes.

The embodiments of the present disclosure are described with reference to flowcharts and/or block diagrams of methods, terminal devices (systems), and computer program products according to the embodiments of the present disclosure. It should be understood that each process and/or block in a flowchart and/or block diagram, and a combination of processes and/or blocks in the flowchart and/or block diagram can be implemented by computer program instructions. These computer program instructions can be provided to a processor of a general-purpose computer, a special-purpose computer, an embedded processor, or other programmable data processing terminal device to generate a machine, so that an apparatus used for implementing functions specified in one or more processes in a flowchart and/or one or more blocks in a block diagram is generated by executing the instructions using the processor of the computer or other programmable data processing device.

These computer program instructions can also be stored in a computer-readable storage device that can guide a computer or other programmable data processing terminal device to work in a specific way, so that the instructions stored in the computer-readable storage device produce an article of manufacture including an instruction apparatus. The instruction apparatus implements functions specified in one or more processes in a flowchart and/or one or more blocks in a block diagram.

These computer program instructions can also be loaded on a computer or other programmable data processing terminal device, so that a series of operation steps are executed on the computer or other programmable device to produce computer-implemented processing, so that the instructions executed on the computer or other programmable device provide steps for implementing functions specified in one or more processes in a flowchart and/or one or more blocks in a block diagram.

Although the exemplary embodiments of the embodiments of the present disclosure have been described, one skilled in the art can make additional changes and modifications to these embodiments once they learn the basic creative concept. Therefore, the appended claims are intended to be interpreted as including the exemplary embodiments and all the changes and modifications that fall within the scope of the embodiments of the present disclosure.

Finally, it should be noted that in this article, relational terms, such as first and second, etc., in the present text are only used to distinguish one entity or operation from another entity or operation, and do not necessarily require or imply any such actual relationship or sequence between these entities or operations. Moreover, the terms “containing”, “including” or any other variations thereof are intended to cover a non-exclusive inclusion, so that a process, method, article, or terminal device that includes a series of elements includes not only these elements, but also other elements that are not explicitly listed, and elements that are inherent to such process, method, article, or terminal device. Without further limitations, an element defined by a sentence “including a . . . ” does not exclude an existence of other identical elements in a process, method, article, or terminal device that includes such element.

Details of the network communication methods and apparatuses that are provided have been described above. Specific examples are used in the present text to illustrate the principles and implementations of the present disclosure. The descriptions of the above embodiments are only used to help understand the methods of the present disclosure and their core ideas. At the same time, for one of ordinary skill in the art, changes in specific implementations and the scope of applications could exist according to the ideas of the present disclosure. In summary, the content of the present specification should not be construed as limiting the present disclosure.

The present disclosure can further be understood using the following clauses.

Clause 1: A network communication method, which is applied to user equipment, the method comprising: the user equipment receiving an update message sent by a second network entity through a third network entity, wherein the update message is used to update a terminal route selection policy rule, the terminal route selection policy rule includes a network identification, and the network identification is used to enable the user equipment to select a corresponding network according to an target application; and the user equipment sending an update reply message for the update message to the third network entity, to cause the third network entity to send the update reply message to the second network entity.

Clause 2: The method according to Clause 1, wherein before the user equipment receives the update message sent by the second network entity through the third network entity, the method further includes: the user equipment predefining the route selection policy rule, wherein the route selection policy rule includes the network identification.

Clause 3: The method according to Clause 2, further comprising: the user equipment updating first network identification list information according to the network identification in the route selection policy rule, wherein the first network identification list information includes network identification(s) that the user equipment is allowed to attempt to access.

Clause 4: The method according to any one of Clauses 1-3, wherein the network identification includes at least one of the following: a public land mobile network identification, and a non-public network identification.

Clause 5: The method according to Clause 1, wherein the update message is sent by the first network entity to the user equipment through the second network entity and the third network entity.

Clause 6: A network communication method, which is applied to user equipment, the method comprising: the user equipment receiving a broadcast message, wherein the broadcast message includes a target network identification; the user equipment determining a network identification from a terminal route selection policy rule corresponding to a target application, and matching the determined network identification with the target network identification when an access to the target application is triggered; and the user equipment performing network registration according to the target network identification.

Clause 7: The method according to Clause 6, wherein the network identification includes at least one of the following: a public land mobile network identification, and a non-public network identification.

Clause 8: A network communication method, which is applied to a third network entity, the method comprising: the third network entity receiving an update message from a second network entity and sending the update message to user equipment, wherein the update message is used to update a terminal route selection policy rule, the terminal route selection policy rule includes a network identification, and the network identification is used to enable the user equipment to select a corresponding network according to a target application; and the third network entity receiving an update reply message for the update message from the user equipment, and sending the update reply message to the second network entity.

Clause 9: The method according to Clause 8, wherein before the third network entity sends the update message to the user equipment, the method further comprises: the third network entity determining whether the user equipment is registered with the network; and the third network entity triggering a network registration process when determining that the user equipment is not registered with the network.

Clause 10: The method according to Clause 8 or 9, wherein the network identification includes at least one of the following: a public land mobile network identification, and a non-public network identification.

Clause 11: The method according to Clause 8 or 9, wherein the update message is sent by the first network entity to the user equipment through the second network entity and the third network entity.

Clause 12: A network communication method, which is applied to a second network entity, the method comprising: the second network entity sending an update message to user equipment through a third network entity, wherein the update message is used to update a terminal route selection policy rule, the terminal route selection policy rule includes a network identification, and the network identification is used to enable user equipment to select a corresponding network according to a target application; and the second network entity receiving an update reply message for the update message from the user equipment through the third network entity.

Clause 13: The method according to Clause 12, wherein the network identification includes at least one of the following: a public land mobile network identification, and a non-public network identification.

Clause 14: The method according to Clause 12 or 13, wherein the update message is sent by the first network entity to the user equipment through the second network entity and the third network entity.

Clause 15: A network communication method, which is applied to a first network entity, the method comprising: the first network entity sending an update message to the user equipment through a second network entity and a third network entity, wherein the update message is used to update a terminal route selection policy rule, the terminal route selection policy rule includes a network identification, and the network identification is used to enable the user equipment to select a corresponding network according to a target application.

Clause 16: The method according to Clause 15, wherein the network identification includes at least one of the following: a public land mobile network identification, and a non-public network identification.

Clause 17: A network communication apparatus, which is applied in user equipment, the apparatus comprising: an update message receiving module configured to receive an update message sent by a second network entity through a third network entity, wherein the update message is used to update a terminal route selection policy rule, the terminal route selection policy rule includes a network identification, and the network identification is used to enable user equipment to select a corresponding network according to a target application; and an update reply message sending module configured to send an update reply message for the update message to the third network entity, to cause the third network entity to send the update reply message to the second network entity.

Clause 18: The apparatus according to Clause 17, further comprising: a route selection policy rule presetting module configured to preset the route selection policy rule, and the route selection policy rule includes the network identification.

Clause 19: The apparatus according to Clause 18, further comprising: a first network identification list information update module configured to update first network identification list information according to the network identification in the route selection policy rule, wherein the first network identification list information includes network identification(s) that the user equipment is allowed to attempt to access.

Clause 20: The apparatus according to any one of Clauses 17-19, wherein the network identification includes at least one of the following: a public land mobile network identification, and a non-public network identification.

Clause 21: The apparatus according to Clause 17, wherein the update message is sent by the first network entity to the user equipment through the second network entity and the third network entity.

Clause 22: A network communication apparatus, which is applied in user equipment, the apparatus comprising: a broadcast message receiving module configured to receive a broadcast message, wherein the broadcast message includes a target network identification; a network identification matching module configured to determine a network identification from the terminal route selection policy rule corresponding to an target application when an access to the target application is triggered, and match the network identification with the target network identification; and a network registration module configured to perform network registration according to the target network identification.

Clause 23: The apparatus according to Clause 22, wherein the network identification includes at least one of the following: a public land mobile network identification, and a non-public network identification.

Clause 24: A network communication apparatus, which is applied to a third network entity, the apparatus comprising: an update message forwarding module configured to receive an update message from a second network entity and send the update message to user equipment, wherein the update message is used to update a terminal route selection policy rule, the terminal route selection policy rule includes a network identification, and the network identification is used to enable the user equipment to select a corresponding network according to a target application; and an update reply message forwarding module configured to receive an update reply message for the update message from the user equipment, and send the update reply message to the second network entity.

Clause 25: The apparatus according to Clause 24, further comprising: a registered network determination module configured to determine whether the user equipment is registered with the network, and call a network registration process trigger module when determining that the user equipment is not registered with the network; and the network registration process trigger module configured to trigger a network registration process.

Clause 26: The apparatus according to Clause 24, wherein the network identification includes at least one of the following: a public land mobile network identification, and a non-public network identification.

Clause 27: The apparatus according to Clause 24 or 25, wherein the update message is sent by the first network entity to the user equipment through the second network entity and the third network entity.

Clause 28: A network communication apparatus, which is applied to a second network entity, the apparatus comprising: a first update message sending module configured to send an update message to user equipment through a third network entity, wherein the update message is used to update a terminal route selection policy rule, the terminal route selection policy rule includes a network identification, and the network identification is used to enable user equipment to select a corresponding network according to a target application; and an update reply message receiving module configured to receive an update reply message for the update message from the user equipment through the third network entity.

Clause 29: The apparatus according to Clause 28, wherein the network identification includes at least one of the following: a public land mobile network identification, and a non-public network identification.

Clause 30: The apparatus according to Clause 28 or 29, wherein the update message is sent by the first network entity to the user equipment through the second network entity and the third network entity.

Clause 31: A network communication apparatus, which is applied to a first network entity, the apparatus comprising: a second update message sending module configured to send an update message to user equipment through a second network entity and a third network entity, wherein the update message is used to update a terminal route selection policy rule, the terminal route selection policy rule includes a network identification, and the network identification is used to enable the user equipment to select a corresponding network according to a target application.

Clause 32: The apparatus according to Clause 31, wherein the network identification includes at least one of the following: a public land mobile network identification, and a non-public network identification.

Clause 33: A network communication method, which is applied to a fifth network entity, the method comprising: the fifth network entity receiving a second message sent by a fourth network entity, wherein the second message includes a first policy rule, and the first policy rule includes a network identification; and the fifth network entity sending a third message to a sixth network entity, wherein the third message includes a first policy rule, the first policy rule includes a network identification, the third message is used to cause the sixth network entity to send a fourth message to user equipment through a seventh network entity, the fourth message includes the first policy rule, the first policy rule includes the network identification, and the network identification is used to enable the user equipment to select a corresponding network according to the target application.

Clause 34: The method according to Clause 33, wherein the network identification includes at least one of the following: a public land mobile network identification, and a non-public network identification.

Clause 35: The method according to Clause 33 or 34, wherein the second message is a message sent by the fourth network entity to the fifth network entity after receiving the first message sent by the first network entity, and the first message includes the network identification, and includes at least one of the following: an application identification, a data network name, and network slicing identification information.

Clause 36: The method according to Clause 33, wherein the second message further includes a first identification, and the first identification is used to cause the fifth network entity to send a third message to the sixth network entity.

Clause 37: The method according to Clause 36, wherein the third message further includes the first identification, and the first identification is further used to cause the sixth network entity to send the first policy rule to the user equipment in a specified manner.

Clause 38: A network communication method, which is applied to user equipment, the method comprising: the user equipment receiving a fourth message from a sixth network entity through a seventh network entity, wherein the fourth message includes a first policy rule, the first policy rule includes a network identification, the network identification is used to enable the user equipment to select a corresponding network according to a target application, the fourth message is a message sent by the sixth network entity to the user equipment after receiving a third message sent by a fifth network entity, the third message includes the first policy rule, the first policy rule includes the network identification, the third message is sent by the fifth network entity to the sixth network entity after receiving a second message sent by a fourth network entity, the second message includes the first policy rule, and the first policy rule includes the network identification; and the user equipment returning a reply message for the fourth message to the sixth network entity through the seventh network entity.

Clause 39: A network communication method, which is applied to a sixth network entity, the method comprising: the sixth network entity receiving a sixth message sent by a fourth network entity, wherein the sixth message includes a second policy rule, and the second policy rule includes a network identification; and the sixth network entity sending a seventh message to user equipment through a seventh network entity, the seventh message includes the second policy rule, the second policy rule includes the network identification, and the network identification is used to enable the user equipment to select a corresponding network according to a target application.

Clause 40: The method according to Clause 39, further comprising: the sixth network entity receiving a reply message for the seventh message from the user equipment through a seventh network entity.

Clause 41: The method according to Clause 39 or 40, wherein the network identification includes at least one of the following: a public land mobile network identification, and a non-public network identification.

Clause 42: The method according to Clause 39 or 40, wherein the sixth message is a message sent by the fourth network entity to the sixth network entity after receiving a fifth message sent by a first network entity, and a network identification of the fifth message further includes at least one of the following: an application identification, a data network name, and network slicing identification information.

Clause 43: The method according to Clause 39, wherein the sixth message further includes a first identification, and the first identification is used to cause the sixth network entity to send the second policy rule to the user equipment in a specified manner.

Clause 44: A network communication method, which is applied to user equipment, the method comprising: the user equipment receiving a seventh message from a sixth network entity through a seventh network entity, wherein the seventh message includes a second policy rule, the second policy rule includes a network identification, the network identification is used to enable the user equipment to select a corresponding network according to a target application, the seventh message is a message sent by the sixth network entity to the user equipment through the seventh network entity after receiving a sixth message sent by a fourth network entity, the sixth message includes the second policy rule, and the second policy rule includes the network identification; and the user equipment returning a reply message to the seventh message to the sixth network entity through the seventh network entity.

Clause 45: A network communication apparatus, which is applied in a fifth network entity, the apparatus comprising: a second message receiving module configured to receive a second message sent by a fourth network entity, wherein the second message includes a first policy rule, and the first policy rule includes a network identification; and a third message sending module configured to send a third message to a sixth network entity, wherein the third message includes the first policy rule, the first policy rule includes the network identification, and the third message is used to enable the sixth network entity to send a fourth message to user equipment through a seventh network entity, the fourth message includes the first policy rule, the first policy rule includes the network identification, and the network identification is used to enable the user equipment to select a corresponding network according to a target application.

Clause 46: A network communication apparatus, which is applied in user equipment, the apparatus comprising: a fourth message receiving module configured to receive a fourth message from the sixth network entity through a seventh network entity, wherein the fourth message includes a first policy rule, the first policy rule includes a network identification, the network identification is used to enable the user equipment to select a corresponding network according to a target application, the fourth message is a message sent by the sixth network entity to the user equipment after receiving a third message sent by a fifth network entity, the third message includes the first policy rule, the first policy rule includes the network identification, the third message is a message sent by the fifth network entity sends to the sixth network entity after receiving a second message sent by a fourth network entity, the second message includes the first policy rule, and the first policy rule includes the network identification; and a fourth reply message returning module configured to return a reply message for the fourth message to the sixth network entity through the seventh network entity.

Clause 47: A network communication apparatus, which is applied in a sixth network entity, the apparatus comprising: a sixth message receiving module configured to receive a sixth message sent by a fourth network entity, wherein the sixth message includes a second policy rule, and the second policy rule includes a network identification; and a seventh message sending module configured to send a seventh message to user equipment through a seventh network entity, wherein the seventh message includes the second policy rule, the second policy rule includes the network identification, and the network identification is used to enable user equipment to select a corresponding network according to a target application.

Clause 48: A network communication apparatus, which is applied in user equipment, the apparatus comprising: a seventh message receiving module configured to receive a seventh message from a sixth network entity through a seventh network entity, wherein the seventh message includes a second policy rule, the second policy rule includes a network identification, the network identification is used to enable the user equipment to select a corresponding network according to a target application, the seventh message is a message sent by the sixth network entity the user equipment through the seventh network entity after receiving a sixth message sent by a fourth network entity, the sixth message includes the second policy rule, and the second policy rule includes the network identification; and a seventh reply message returning module configured to return a reply message for the seventh message to the sixth network entity through the seventh network entity.

What is claimed is:

1. A method implemented by user equipment, the method comprising:
receiving an update message sent by a second network entity through a third network entity, wherein the update message is used to update a terminal route selection policy rule, the terminal route selection policy rule includes a network identification, and the network identification is used to enable the user equipment to select a corresponding network according to an target application; and
sending an update reply message for the update message to the third network entity, to cause the third network entity to send the update reply message to the second network entity.

2. The method according to claim 1, further comprising:
predefining the terminal route selection policy rule before receiving the update message sent by the second network entity through the third network entity.

3. The method according to claim 2, further comprising:
updating a first network identification list information according to the network identification in the terminal route selection policy rule

4. The method according to claim 3, wherein the first network identification list information includes one or more network identifications that the user equipment is allowed to attempt to access.

5. The method according to claim 1, wherein the network identification includes at least one of:
a public land mobile network identification, and a non-public network identification.

6. The method according to claim 1, wherein the update message is sent by a first network entity to the user equipment through the second network entity and the third network entity.

7. The method according to claim 1, further comprising:
receiving a broadcast message, wherein the broadcast message includes a target network identification; and
determining a network identification from a terminal route selection policy rule corresponding to a target application.

8. The method according to claim 7, further comprising:
matching the determined network identification with the target network identification when an access to the target application is triggered; and
performing network registration according to the target network identification.

9. One or more computer readable media storing executable instructions that, when executed by one or more processors of a third network entity, cause the one or more processors to perform acts comprising:
receiving an update message from a second network entity and sending the update message to user equipment, wherein the update message is used to update a terminal route selection policy rule, the terminal route selection policy rule includes a network identification, and the network identification is used to enable the user equipment to select a corresponding network according to a target application; and
receiving an update reply message for the update message from the user equipment, and sending the update reply message to the second network entity.

10. The one or more computer readable media according to claim 9, wherein before the third network entity sends the update message to the user equipment, the acts further comprise:
determining whether the user equipment is registered with the network; and
triggering a network registration process when determining that the user equipment is not registered with the network.

11. The one or more computer readable media according to claim 9, wherein the network identification includes at least one of:
a public land mobile network identification, and a non-public network identification.

12. The one or more computer readable media according to claim 9, wherein the update message is sent from a first network entity to the user equipment through the second network entity and the third network entity.

13. An apparatus comprising:
one or more processors;
memory;
an update message receiving module stored in the memory and executable by the one or more processors that is configured to receive an update message sent by a second network entity through a third network entity, wherein the update message is used to update a terminal route selection policy rule, the terminal route selection policy rule includes a network identification, and the network identification is used to enable user equipment to select a corresponding network according to a target application; and
an update reply message sending module stored in the memory and executable by the one or more processors that is configured to send an update reply message for the update message to the third network entity, to cause the third network entity to send the update reply message to the second network entity.

14. The apparatus according to claim 13, further comprising:
a route selection policy rule presetting module configured to preset the terminal route selection policy rule, and the route selection policy rule includes the network identification.

15. The apparatus according to claim 14, further comprising:
a first network identification list information update module configured to update a first network identification list information according to the network identification in the terminal route selection policy rule.

16. The apparatus according to claim 15, wherein the first network identification list information includes one or more network identifications that the user equipment is allowed to attempt to access.

17. The apparatus according to claim 13, wherein the network identification includes at least one of:
a public land mobile network identification, and a non-public network identification.

18. The apparatus according to claim 13, wherein the update message is sent by a first network entity to the user equipment through the second network entity and the third network entity.

19. The apparatus according to claim 13, further comprising:
a broadcast message receiving module configured to receive a broadcast message, wherein the broadcast message includes a target network identification.

20. The apparatus according to claim 19, further comprising:
a network identification matching module configured to determine a network identification from the terminal route selection policy rule corresponding to an target application when an access to the target application is triggered, and match the network identification with the target network identification; and
a network registration module configured to perform network registration according to the target network identification.
